(19) United States
(12) Patent Application Publication
(10) Pub. No.: US 2026/0246422 A1
(43) Pub. Date: Aug. 20, 2026

(54) A structural photovoltaic (PV) panel and reinforced frame element adapted for modular construction and enclosures and PV devices formed therefrom

(71) Applicant: Maurice Briggs, Norwich (GB)

(72) Inventor: Maurice Briggs, Norwich (GB)

(21) Appl. No.: 19/159,343

(22) PCT Filed: Apr. 23, 2024
(86) PCT No.: PCT/IB2024/053965

§ 371 Date: Aug. 25, 2025

(30) Foreign Application Priority Data
Feb. 23, 2023 (GB) 2302580.2

(51) Int. Cl. H02S 30/10; B60L 53/30; B60L 53/51; B60L 53/66; H02S 10/20; H02S 20/25; H02S 40/36

(52) U.S. Cl. CPC H02S 30/10; B60L 53/305; B60L 53/51; B60L 53/665; H02S 10/20; H02S 20/25; H02S 40/36; B60L 2200/12; B60L 2200/24; B60L 2210/42

(57) ABSTRACT

The invention describes a structural frame element adapted to accommodate photovoltaic (PV) modules to form a photovoltaic panel capable of being used as a construction element. A framed PV panel adapted to be coupled to further framed PV panels to form an array for mounting on structure surfaces and to form walls, roofs and doors of self-supporting structures, enclosures and equipment cabinets. The invention describes a structural frame element adapted to accommodate photovoltaic (PV) modules to form a PV panel capable of being used as a construction element to facilitate the coupling of framed PV panels together for fixing PV panels to existing structures and for forming said self-supporting structures, enclosures and equipment cabinets. Reinforcement members embedded within the frame elements provide busbar connectivity for the PV panels.

### FIELD OF THE INVENTION

The present invention relates to structural frame elements comprising or adapted to accommodate photovoltaic (PV) modules to form a photovoltaic panel capable of being used as a construction element.

The present invention further relates to the provision of structural components to facilitate the coupling of framed PV panels for fixing PV panels to existing structures and for forming said self-supporting structures, enclosures and equipment cabinets.

The present invention more specifically relates to a framed PV panel adapted to be coupled to further framed PV panels to form an array for mounting on structure surfaces and to form walls, roofs and doors of self-supporting structures, enclosures and equipment cabinets.

The present invention yet further relates to the formation of self-supporting structures, enclosures and equipment cabinets utilising framed PV panels and further structural components to provide the required structural integrity thereto.

The present invention additionally relates to the design and installation of structures and enclosures having attached thereto or integrally formed therewith photovoltaic (PV) panels arranged thereon to provide an optimised power source for internally or externally connected devices, the structures or enclosures being particularly directed to PV devices suited for remote sites and latitudes where solar energy is unreliable or highly variable, especially from season to season.

Specifically, the invention relates to the provision of a range of self-supporting structures, enclosures and equipment cabinets incorporating photovoltaic (PV) panels for providing collected and stored energy for on-demand delivery.

The invention further relates to the provision of enclosures and equipment cabinets for remote and off-grid locations which are robust and of enhanced durability.

The present invention is also directed towards the provision of a range of self-supporting structures, enclosures and equipment cabinets incorporating PV power generating apparatus having additional features which in combination provide superior utility and functionality on location.

The invention is also directed to achieving a balance of physical, environmental, financial and electrical constraints that represents the best overall compromise to provide a “useful amount” of electrical power each day of the year, irrespective of season, weather conditions and cloud cover, optionally independent of external power sources and away from a fixed source of power (such a mains grid power).

Ideally, said self-supporting structures, enclosures and equipment cabinets of the invention achieves its objective via a single source of power, that is, via solar radiation with battery pack accumulation for delivering power during the night. The apparatus may also be used with a wind turbine to augment power generation and storage.

The present invention yet further relates to the formation of self-supporting structures, enclosures and equipment cabinets utilising reinforced framed PV panels and further structural components of the invention.

In a further aspect, the invention relates to an enclosure or unitary structure that is weatherproof, robust, easily maintained and is deployable or transportable to remote and off-grid locations to provide a useful daily power output in sub-optimal conditions, specifically during the months of lowest average harvestable solar radiation.

The present invention relates also to the design and installation of a charging station for charging batteries of an electric vehicle (EV) utilising predominantly or exclusively energy accumulated via PV panels mounted to or forming the major part of a structure or enclosure.

The invention yet further relates to a charging station for electric vehicles (EVs) suitable for use where connection to mains electrical power is inconvenient, expensive or disruptive to high traffic locations and sites of significant cultural or natural significance.

The invention particularly relates to the provision of a structure or enclosure for charging batteries of an EV vehicle whether said batteries are removed from an EV for a charging cycle or where the EV is coupling directly to charging point within the structure or enclosure and most particularly to the accommodation, securing or storage of EVs or batteries used therein to facilitate charging thereof utilising power predominantly derived from solar radiation via PV panels or arrays thereof.

The invention relates most particularly a self-powered, self-supporting charging station for batteries for electric vehicles (EVs), particularly single person EVs such as electric motorcycles, bicycles and foot scooters.

The invention additionally relates to an optimised PV power generator on which structural PV panels operably form the major vertical faces thereof to optimise the harvesting of solar radiation in sub-optimal conditions with respect to diurnal and seasonal variances of direct and indirect incidence of solar radiation, the generator being particularly suited for remote and/or culturally sensitive sites where mains supply is unavailable or where solar energy is unreliable or highly variable.

The invention yet further additionally relates to an off-grid solar powered generator that provides consistent rated power in locations having high seasonal variance of solar energy, for example, in all latitudes of the United Kingdom (UK) in all seasons which does not necessitate a supplementary energy generation source and, in a second aspect relates to a hybrid grid generator which is connectable to additional power generators of the invention, supplementary power sources and/or mains power for regional or national grid infrastructure. Mainland UK lies between the latitudes of 50° N and 59° N and experiences a significant variance in the average angle of incidence of solar radiation between summer and winter. There are many other countries sharing similar northerly latitudes (including a major part of Canada, Northern Europe and a large swathe of the Russian Federation), however, only the southern tips of Chile and Argentina have notable population centres in the corresponding southern latitudes.

The terms “generator unit” and “unitary structure” as used herein are directed primarily to an enclosure or closed cabinet within which control circuitry is secured and protected against weather and interference by the curious. The term extends also structures adapted to support solar/photovoltaic panels and adapted to connect to ancillary sources of power, such as accumulator batteries, motor generators, wind turbine, amongst others, and, of course, the mains grid. The scope of the invention, however, is not intended to be so limiting and should be taken to include any ruggedised enclosure adapted to be deployed to remote locations and hoisted or otherwise elevated during its positioning at or recovery from a site. This is particularly relevant where the deployment or recover weight may be significant more than that of the unit when empty and applies equally to enclosures housing battery packs.

The terms “enclosure” and “cabinet” as used herein are intended to indicate a unit or construction made as a unitary power generator and which is adapted to be coupled to ancillary power sources and additional units (which may be formed into a bank or array).

Although the term “useful quantities” is used with reference to a desired daily power output from the generator unit during seasonal minima of solar radiation (November, December and January in northern latitudes), no limitation ought to be placed on the rated power of the apparatus as a whole which can be connected to and have its power output augmented by additional generator units or external sources, including mains power. Furthermore, the term “useful quantities” has specific meaning within different contexts as will be described hereinbelow with reference to the numerous uses to which the generator apparatus may be applied.

### BACKGROUND TO THE INVENTION

There are numerous methodologies and technologies utilised for extracting energy from the sun, each having their respective advantages and disadvantages depending on the application to which they are put and factors ranging from environmental impact to capital and maintenance costs.

One of the areas where most technological improvement has been made is in the sphere of harvesting, storing and distributing solar energy, collected via photovoltaic (PV) cells, most often arranged in banks of interconnected cells to form modules, with multiple modules making up a “solar panel”.

With exposure to nominal illumination by sunlight, each PV cell is capable of producing approximately 0.6V and when combined within a 72-cell panel is capable of yielding 300 W. Thus, a modular panel can deliver useful amounts of electrical energy in direct sunlight. This has become the de facto implementation for domestic roof-mounted systems and for commercial and large-scale “solar farms” comprising an array of ground-mounted panels for producing power for commercial enterprises from farms to data centres and for connection to national or regional grid power systems.

The factors regarding the harvesting of solar photovoltaic power referenced in more details below are different for commercial and large-scale implementation than for domestic and remote-site (or “off-grid”) implementations and it is in this latter area that the present invention is particularly concerned.

Capital cost of PV modules and panels has reduced markedly in recent years with the industrialization of printed PV cell technology and the ready availability of modules with integrated DC-DC converters and microinverters. With the reduction in the cost of harvesting solar energy and the need for a near constant supply of energy in off-grid and domestic applications (even at low or nominal levels), particularly where the cost of supplied energy may be prohibitive, focus must now be brought to the storage of generated energy.

Insolation is the term given to the amount of radiation or exposure at certain locations, however, in terms of harvesting solar energy, there are numerous factors at play. Of most significance is seasonal variation at particular latitudes where the intensity of solar radiation even at seasonal maximum is insufficient to provide useable levels of electrical power and additional sources must be utilised.

For any given latitude, an average or optimal panel angle may be calculated, however, with any selected angle towards the vertical there are factors to be considered such as structural strength to resist incident wind forces. Similarly, structural strength must also to be considered at panel angles towards the horizontal where snow loading becomes important. Obviously, a covering of snow severely impacts the harvesting of solar radiation. In less severe conditions, the settling of dust or debris on the panels means that panels require regular cleaning to maintain optimal harvesting.

It is well-established practise to align solar panels to an azimuth corresponding to a particular latitude or to select different azimuths in chosen panels in a solar array to account for seasonal variations.

The prior art is replete with structures and arrangements for tracking in the path of the sun to optimise the incidence of solar radiation on the receiving surface of the PV cells, however, irrespective of whether single-axis tracking is employed (for example, diurnal tracking) or dual-axis tracking following both diurnal and seasonal variations, all are at significant additional cost and inherent complexity. For remote transportable or at least moveable PV generators, robustness and service longevity is a must.

As will be readily appreciate from the patent literature, there are many different approaches taken to solving some of the technical disadvantages. Each area presents specific concerns, however, many aspects are common and will be addressed hereinafter.

It is acknowledged that within the prior art there are buildings and devices onto which PV panels have been secured in a vertical orientation. The primary expressed reason for doing to is that there are convenient vertical surfaces available and little real thought is given to their placement beyond convenience, it being considered a significant compromise to positioning on a vertical face.

International Patent Application Publication No. WO 2023/019362 to SOLIDEL CANADA INC. discloses a vertical structure comprising a lamp post on which there is mounted a plurality of photovoltaic panels adapted to store solar energy collected during daylight hours to power a street lamp from a coupled battery during hours of darkness. The invention claimed is distinguished from earlier solar powered lamp posts by the provision of PV panels along the length of the structure rather than providing a panel or array angled according to latitude. By arranging a larger surface area of solar panel to be configured around the vertical riser of the post, the known disadvantage of insufficient power accumulation for illuminating a street lamp is addressed.

Chinese Patent Publication No. CN 107882364 to XIAOCHANG RUIKE INTELLEGENT TECH CO LTD describes a small outdoor seating structure having a sunshade in the form of an awning. Between a pair of bench seats, a table has a central column for supporting an electric cooling fan, powered from batteries stored within a seat base. At the top of corner support pillars, a horizontal solar panel forms a roof structure. An additional vertically disposed PV panel is connected to the roof panel and secured between two of the upright support pillars. The disclosure is directed only to the powering of the cooling fan.

United States Patent Publication No. US 2017/0141721 to SCHMIDT, ROBERT F describes a modular portable photovoltaic solar powered electrical generation, storage and supply device and light tower. The device consists of an elongated cube or rectangular prism shaped support structure with a flat base, flat sides and a flat decked top to form a protective crate shaped module when the various components, such as the solar panel arrays, telescoping mast, and light assembly or outriggers of the device are retracted to where the boundaries may be defined by the perimeters of the cube or prism. This modular design can allow for the modules to be stored, loaded, or shipped quickly, efficiently, and in greater quantities on flatbeds, in shipping containers, in warehouses, and other settings and modes where they can not only be packed end to end and side to side with no unused space, but can also be stacked up to three modules high for significantly higher storage density. The interconnectivity of multiple modules to create incrementally larger power generation, storage and distribution systems provides an easily adaptable solution to larger temporary power demands.

Further single load applications may include the charging of an EV and numerous examples of using PV panels to supplement EV charging are known.

Chinese Patent Publication No. CN 107733067 to XIAOGAN QUILE CREATIVE DESIGN CO LTD describes a solar charging shed comprising a structure (which may be used as a parking garage/shed for a vehicle) having support pillars for a roof-mounted solar panel and a side wall solar panel. The panels are connected to a battery pack which includes a current stabilizing device on which a charging interface is arranged. The shed facilitates the storage of solar energy within the battery bank for use charging the vehicle.

International Patent Publication No. WO 2003/012806 to SOLAR FENCE GROUP LTD discloses an architectural construction component comprising a prefabricated element on which a plurality of solar cells is mounted on solar cell carriers, in essence a PV panel. Surfaces of the PV panels include prisms or facets to collect solar energy from multiple angles. The solar cell carriers include lightweight transparent or translucent materials allowing the panels to be used on greenhouses. Constructions including vertically disposed PV panels or structures to which PV panels are secured in a vertical orientation are also disclosed for physical structural benefits as well as providing solar power.

International Patent Application Publication No. WO 2023/170416 to SOLIVUS LIMITED discloses a development of the solar electrical generator of International Patent Application Publication No. WO 2020/039181 also to SOLIVUS LIMITED utilising TFPV cells to obviate reliance on flat silicon wafer panels and similar technologies. Substantially as before, the invention relates to a solar electrical generator comprising an outer wall defining a cavity therein. The outer wall comprises a frame formed from a plurality of extrusions each having channels, the extrusions being arranged so that the channels on adjacent extrusions face one another. The objective being to provide back-to-back flexible solar panels between pairs of supporting extrusions.

Korean Patent Publication No. KR 1020210014255 to LIEN FENG HSUEH describes a waterproof structure (frame) for securing a PV panel to a building, the PV panel being secured within frame elements having water drainage channels and waterproof fixings. Also disclosed are a method of and fixings for securing panels for a roof and to a wall.

To provide improved handling of PV panels a lightweight frame is disposed around the periphery of each panel. Standard frames comprise an aluminium extrusion, which has a mounting flange and an edge profile to engage and retain the substrate upon which PV modules are fixed and a protective overlying laminate or film. Standard PV panels are formed with 60 or 72 modules connected together on the substrate and mounted within the lightweight frame which provides a modicum of edge protection and minimal rigidity or integrity to the panel as a unitary structure. 60-module panels have approximate dimensions of 1.0×1.6 metres (39×65 inches) whereas 72-module panels have approximate dimensions of 1.0×2.0 metres (39×78 inches) with outputs in the range of 350 to 400 W and 450 to 500 W, respectively, depending on the cell technology used. During installation, PV panels are mounted to support structures which can add to the overall weight and cost of the installation. Each panel requires electrical connection either to an adjacent panel or to a charge controller assigned to the panels according to the selected connection configuration. Each selected configuration has voltage and current considerations, ranging from safety to the rating of cables, connectors and electronic components, such as inverters or Maximum Power Point Tracking (MPPT) controllers.

Cabling is an ongoing consideration for all PV panel installation and solutions provided are often rudimentary.

United States Patent Application Publication No. US 2019/013774 to TESCI Solar, Inc. discloses a modified lightweight frame having additional flanges adapted for cable management and for the attachment of microinverters thereto. The disclosure fails to address the limited rigidity and structural integrity of PV panels or the issue of cable management beyond mere ducting.

It is an object of the present invention to seek to alleviate the disadvantages of the prior art arrangements and to provide structural frame elements adapted to accommodate photovoltaic (PV) modules to form a structural panel capable of being used as a construction element.

It is a further object of the invention to provide structural components to facilitate the coupling of framed PV panels for fixing PV panels to existing structures and for forming said self-supporting structures, enclosures and equipment cabinets.

It is a yet further object of the invention to provide a framed PV panel adapted to be coupled to further framed PV panels to form an array for mounting on structure surfaces and to form walls, roofs and doors of self-supporting structures, enclosures and equipment cabinets.

A further object of the invention is to provide an alternative PV panel electrical connection paradigm obviating a significant proportion of cabling and associated labour costs.

It is an additional object of the present invention to provide means and method of construction of self-supporting structures, enclosures and equipment cabinets utilising framed PV panels and further structural components of the invention suitable for remote and off-grid locations which are robust and of enhanced durability.

Further objects of the invention are directed to enclosures, PV devices and PV power generators formed using frame elements and structural PV panels of the invention as will be described in more detail hereinbelow.

### SUMMARY OF THE INVENTION

In a first aspect, the present invention provides a frame element for forming a structural photovoltaic (PV) panel, the frame element comprising:
a structural body providing rigidity to the frame element:
the structural body having an attachment surface and an edge receiving profile;
the structural body being adapted to constrain therein a reinforcing member along substantially the length of the frame element.

The attachment surface ideally is abutted to the lightweight extrusion of a standard PV panel and secured thereto. The edge receiving profile is adapted in one construction to receive a cladding or insulating board. In an alternative arrangement, the extrusion may be accommodated within the edge receiving profile.

In one construction, the reinforcing member is tubular. This arrangement facilitates ducting of cables therethrough.

Advantageously, the reinforcing member is conductive and insulated from the PV panel by the structural body. This arrangement obviates much of the ducting of PV panel cables.

Preferably, the reinforcing member comprises a busbar for a selected polarity rail to which a PV panel is connected.

In one preferred construction, substantially rectangular reinforcing members are positioned proximate one another to attenuate electromagnetic interference (EMI) associated with the conducting of power from the PV panels.

Most preferably, reinforcing members are positioned substantially perpendicularly to one another to provide structural reinforcement in two major axes.

In a further construction, most ideally suited to multi-panel assemblies, positive and negative polarity busbars are provided in one or both of the horizontal and vertical planes.

In a second aspect of the invention there is provided a structural photovoltaic (PV) panel of enhanced rigidity having at least one frame element of the type defined hereinabove, the or each frame element including attachment means selected from any one of:
a fixing member for securing one structural frame element to another;
a ground-engaging foot or fixing;
a fence post having frame receiving channels defined therein; or
a locking member for securing a frame element to a shipping container lock receiver.

Advantageously, the attachment means is operationally adapted to secure a panel to a building or enclosure surface.

It will be appreciated that structurally reinforced PV panel assemblies facilitates the hoisting of roof mountable panels and arrays in pre-assembled form due to inherent strength thereof.

In one construction, the or each frame element is fixed to a framework.

This allows for construction including enclosure frameworks, building mounted frameworks, shipping container frameworks, amongst others.

The invention further provides a structural PV panel comprising a plurality of structural PV panels of the type defined hereinabove positioned within frame receiving channels of a series of fence posts.

Most preferably, structural PV panels are adapted to form a self-supporting enclosure.

Enclosures may be selected from a PV power generating apparatus, equipment cabinet, or remote monitoring station for which at least a minimum maintenance power requirement is satisfied from said PV panels or the accumulation of power therefrom (even in the most hostile environments).

In a third aspect of the invention there is provided a modular photovoltaic (PV) system comprising:
a PV panel;
a structural frame element of the type claimed in Claim 1;
attachment means;
   in which each PV panel is secured to a structural frame element having at least one reinforcing member defined therein, and
   in which the attachment means is selected from any one of:
a fixing member for securing one structural frame element to another;
a ground-engaging foot or fixing;
a fence post having frame receiving channels defined therein; or
a locking member for securing a frame element to a shipping container lock receiver.

The invention further provides in a fourth aspect an enclosure for a photovoltaic (PV) device on which PV panels operably form at least two of the major faces thereof, the enclosure comprising:
structural frame elements of the type claimed in Claim 1 and an attachment means for securing the enclosure to the ground or to a building surface;
a plurality of PV panels secured to the structural frame elements to define vertical faces of the enclosure;
sealingly disposed within the enclosure, control circuitry for regulating the electrical energy generated via the PV panels and energy accumulators connected to the control circuitry; and
a regulated electrical outlet means,
in which at least two of the PV panels are disposed on said major faces, of which at least one is directed towards the arc subtended by the sun (due south in northern latitudes) and the other of said at least two PV panels is selected from PV panels disposed substantially perpendicular to the first PV panel and PV panels mounted to a roof section.

Conveniently, the enclosure is selected from any one of: a prefabricated purpose-built enclosure, a garden shed, a domestic dwelling, a shipping container, a prefabricated metal building (including barns, livestock shelters and silos), industrial buildings, warehouses and distribution centres.

In one particular construction, the enclosure is adapted as a remote monitoring or signal repeating station in which the energy accumulators ensure power is maintained for data collection, storage and transmission.

In an adapted construction, one of the major faces includes an access door.

Optionally, the structural frame elements releasably retain the PV panels and include hinge elements at their peripheries to facilitate access to the interior of the enclosure.

Ideally, each face of an enclosure having a PV panel thereon has associated therewith a dedicated and appropriately rated charge controller to manage the solar power harvested from each panel within a face to maximise the efficiency of the charging output generated.

A particular construction of the enclosure is adapted to receive, store and charge batteries from electric vehicles (EVs).

In an alternative construction, the enclosure is adapted to receive, store and charge EVs from electric kick-scooters, electric motorcycles and electric cars (obviating the necessity of external or mains powered electrical connections).

In a specific construction, the enclosure has an octagonal cross-section whereby framed PV panels are hinged to form access doors to a centrally disposed charging structure on which electric kick scooters are suspended for storage and charging.

In a yet further construction, the enclosure is open on one of its faces and in which at least one face of PV panels comprises an arrangement of formed PV panels in back-to-back configuration so as to receive indirect or reflected solar radiation within the open mouth of the enclosure and whereby EVs have access to charging facilities at the open mouth thereof.

Conveniently, the enclosure includes a communications module.

Optionally or additionally, the enclosure includes payment verification means.

In a fifth aspect, the present invention provides a photovoltaic (PV) power generator apparatus on which PV panels operably form at least two of the major faces thereof, the generator comprising:
a cabinet housing defining said major faces and a roof section thereof, the cabinet having structural frame elements of the type claimed in Claim 1 and an attachment means selected from a ground-engaging element and a building surface securing support;
a plurality of PV panels secured to the structural frame elements to define selected major vertical faces of the cabinet housing;
sealingly disposed within the housing, control circuitry for regulating the electrical energy generated via the PV panels and energy accumulators connected to the control circuitry; and
a regulated electrical outlet means,
in which at least two of the PV panels are disposed on said major faces, of which at least one is directed towards the arc subtended by the sun (due south in northern latitudes) and the other of said at least two PV panels is selected from PV panels disposed substantially perpendicular to the first PV panel and PV panels mounted on a roof section.

Preferably, the energy accumulators comprise a bank of batteries having deep-cycle characteristics and a bank of batteries having high power delivery characteristics and wherein combining cell technologies with charge controllers and voltage monitoring circuitry optimises both charging and delivery of power in sub-optimal conditions.

Ideally, the PV power generator has at least one major vertically disposed face, in which PV panels operably form at least the major faces thereof to optimise the harvesting of solar radiation in sub-optimal conditions with respect to diurnal and seasonal variances of direct and indirect incidence of solar radiation.

Preferably, each face having a PV panel thereon has associated therewith a dedicated and appropriately rated charge controller to manage the solar power harvested from each panel within a face to maximise the efficiency of the charging output generated.

Advantageously, a storage cell array delivers a direct current (DC) power output to devices or a local power connector or via an inverter to provide an alternating current (AC) power output.

The first battery bank comprises a working bank of frequent and deep cycling cells, having superior weight to kWh ratios and the second battery bank comprising a reserve bank providing additional charging capacity and lower charging temperature capabilities that the working bank cells, each bank having charge balancers to compensate for charge state differences during a charging and discharging cycle.

In one arrangement, the first battery bank comprising lithium ion or lithium iron phosphate batteries and the second battery bank comprising Absorbent Glass Mat (AGM) cells, each provided in a configuration associated with the required system voltage.

The total surface area of PV panel is optimised to generate a daily average power generation of at least 200 Wh.

A storage cell array delivers a direct current (DC) power output to devices or a local power connector or via an inverter to provide an alternating current (AC) power output.

The invention yet further provides a kit of parts for forming framed PV panels and system, the kit of parts being detailed hereinbelow.

### BRIEF DESCRIPTION OF THE DRAWINGS

The present invention will now be described more particularly with reference to the accompanying drawings which show, by way of example only, exemplifying embodiments of structural PV components, enclosures and equipment cabinets, including for photovoltaic (PV) powered devices and PV power generators each having a plurality of solar photovoltaic panels fixed thereto or integrally formed therewith, with illustrations of supplementary components therefore, together with constructions of self-supporting and anchored electric vehicle (EV) battery charging stations in accordance with the invention. In the drawings:

FIGS. 1a to 1c are perspective elevations of constructions of structural PV panel to which frame elements providing structural rigidity have been fixed to provide a two-panel assembly;

FIGS. 2a to 2b are perspective elevations of a first embodiment of structural frame element securing two PV panels in a planar assembly;

FIGS. 3a to 3e are perspective elevations of a second embodiment of structural frame element comprising an extrusion having reinforcing members comprising electrical busbars;

FIG. 4a is a perspective elevation of a multi-panel assembly formed using structural frame elements of the invention within which reinforcing members provide busbar interconnection of the PV panels within the assembly;

FIGS. 4b and 4c are cross sectional elevations of a third embodiment and fourth embodiment of structural frame element comprising an extrusion having reinforcing members comprising electrical busbars;

FIG. 5 is a perspective elevation of a cladding boards suitable for attachment to panel assemblies to provide ventilation and active cooling of PV panels;

FIG. 6a is a diagrammatic illustration of the path of the sun in the UK at both the winter and summer equinox (solstice) and the corresponding optimum angle for the position of solar panels;

FIG. 6b is a bar chart showing the average levels of direct and indirect solar radiation that is usable by solar panels for each month of the year at a latitude corresponding to London, United Kingdom (51.5° N);

FIG. 7 is a perspective elevation of a first embodiment of solar power cabinet in accordance with the invention having a structural PV panel located on each external face of the cabinet;

FIG. 8 is a schematic illustration of components of control circuitry housed within the cabinet or enclosure;

FIGS. 9a and 9b are an angled side view and a perspective elevation respectively of an enhanced construction of the first embodiment of solar power cabinet having a PV panel located on each external face of the cabinet;

FIG. 9c is an exposed perspective elevation similar to that of FIG. 9b in which accumulator cells and control circuitry is disposed in an alternative configuration;

FIGS. 9d and 9e are perspective elevations of a further construction of solar power cabinet having a substantially equal PV panel area presented on each external face of the cabinet (each face being provided with a MPPT);

FIGS. 10a and 10b are a detailed side view and a perspective elevation of a construction of generator apparatus similar to that shown in FIGS. 9d and 9e having a pivotable roof section to present a combined landing and charging platform for an autonomous electric vehicle (drone);

FIGS. 11a and 11b are perspective elevations of a further constructions of solar power enclosure comprising a solar shed or garage formed using structural PV panels in accordance with the invention;

FIGS. 11c to 11e are perspective elevations of a particular construction of multi-panel structural PV panel assembly for attachment to a shipping container;

FIGS. 12a and 12b are perspective elevations of an open-faced solar power cabinet in accordance with the invention having a PV panel located on each exposed face;

FIG. 13 is a perspective elevation of a remote monitoring station;

FIG. 14 is a perspective elevation of a generator apparatus of the invention combined with a heat pump;

FIG. 15 is a perspective elevation of a variant of the first embodiment of PV power generator apparatus having a plurality of securable receiving receptables for receiving and charging removeable EV batteries;

FIG. 16a is a perspective elevation of an enclosure similar to that of the second embodiment in which one major surface of the enclosure abuts or is integral with a wall (including a building wall) ideally facing south in northern latitudes having a pitched roof section angled for optimum insolation at the latitude sited;

FIG. 16b is an outlet socket for attaching a power cable where the enclosure is optimised for external power generation, for coupling to an EV for example;

FIG. 17 is a perspective elevation of a generator apparatus having enhanced security features; and

FIG. 18 is a perspective elevation of a generator apparatus having attached to a minor face thereof a communications module which optionally comprise a cellular base station or signal repeater.

FIG. 19a is a perspective elevation of a fourth embodiment of solar power generating apparatus comprising a structural frame on which PV panels are fixed and within which a battery bank and control electronics are sealingly secured;

FIGS. 19b and 19c are perspective elevations of hinge details of at least one frame panel adapted to facilitate access to the interior of the embodiment illustrated in FIG. 19a; and

FIGS. 20a to 20c are perspective elevations of a specific construction of the fourth embodiment of solar power generating apparatus adapted as a charging station and storage enclosure for foldable electric kick scooters.

### DETAILED DESCRIPTION OF THE DRAWINGS

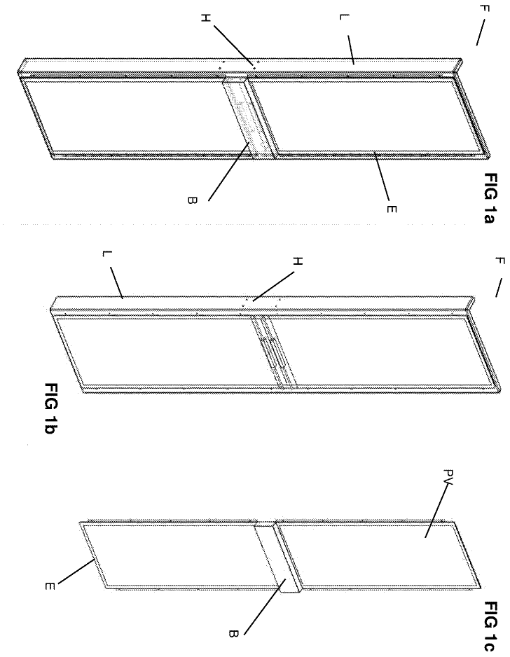

Referring to the drawings and initially to FIGS. 1a to 1c which show structural panel frame components F for retaining a pair of photovoltaic (PV) panels in a two-panel assembly suitable for securing to a building or existing fence panels or for forming a self-supporting structure, including, for example, a PV power generating enclosure.

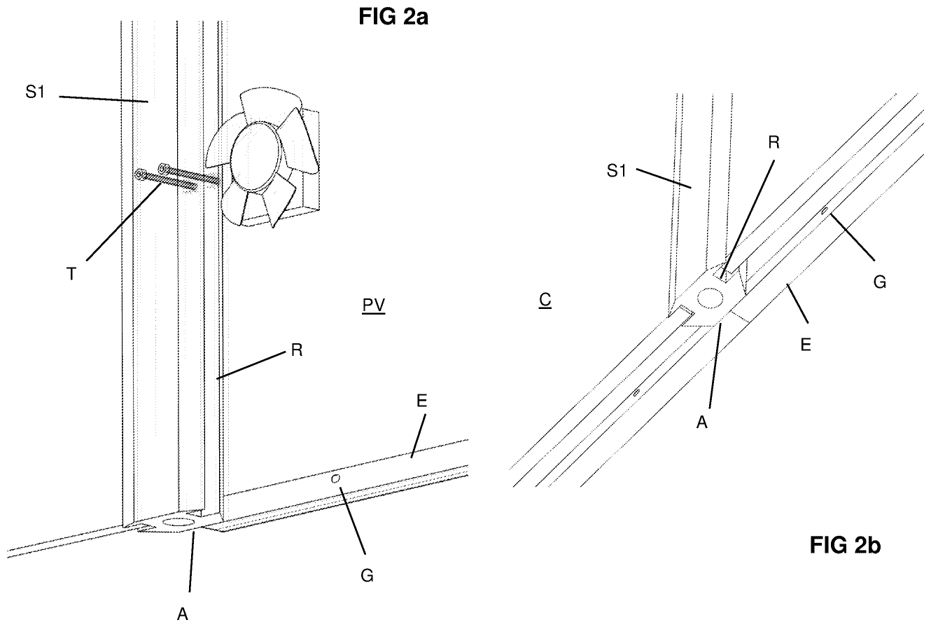

As noted in the preamble, standard PV panels include a lightweight aluminium extrusion E, which, as shown in FIGS. 2a and 2b, normally includes a mounting flange within which there are provides a series of spaced grounding holes G and an edge profile (not shown) to engage and retain the substrate upon which PV modules are fixed and a protective overlying laminate or film. It is well-appreciated that the standard panel extrusion E provides minimal structural integrity and is sufficient only to provide protection to the PV modules within the panels with careful handling. The embodiments of structural frame elements of the invention provide additional structural rigidity to the lightweight extrusions to form a structural PV panel or assemblies thereof.

A first construction of structural frame element F, as shown in FIG. 1a, includes a lip region L for defining the corner of an enclosure in one arrangement or for mounting the panel assembly to an existing framework or face sheet of an enclosure. Fixing holes H are provided along the length of the structural frame element F through which tamper-proof bolts may be utilised to present a tamper-resistant enclosure within which battery accumulators and control circuitry is secured. A PV panel assembly may include a folded box structure B to provide cable routing from the individual PV panels to charge controllers within the enclosure, however, ideally provide a weatherproof housing for a DC-DC converter, micro-inverter or a voltage regulator such as a Maximum Power Point Tracker (MPPT), according to the requirements of the proposed installation. Optionally, a fan or air blower is provided within the housing B to direct air behind the panels for ventilation or directly across the outer face of the panels for cooling.

As will be described in more detail hereinbelow, the structural PV panels or assemblies thus formed are ideal for construction of enclosures comprising or including PV powered equipment, including PV power generating apparatus.

In the preferred constructions of the enclosures, the structural frame elements F form the framework of the enclosure and the PV panels secured thereto form the major faces thereof, in many instances obviating the requirement of an enclosure to which standard PV panels may be secured. As will be appreciated by the skilled addressee, internal racking may be utilised and form part of the structural integrity of the enclosure.

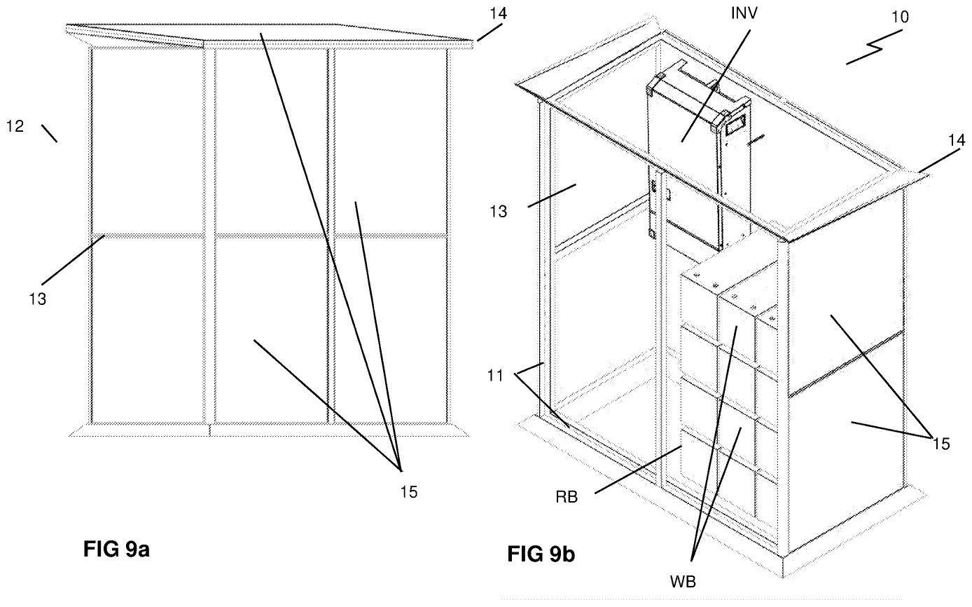

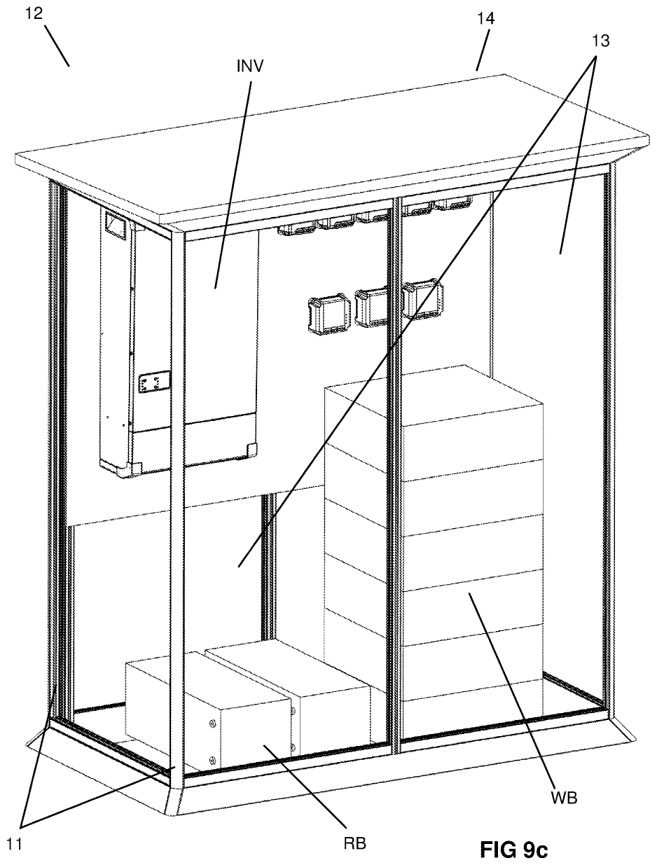

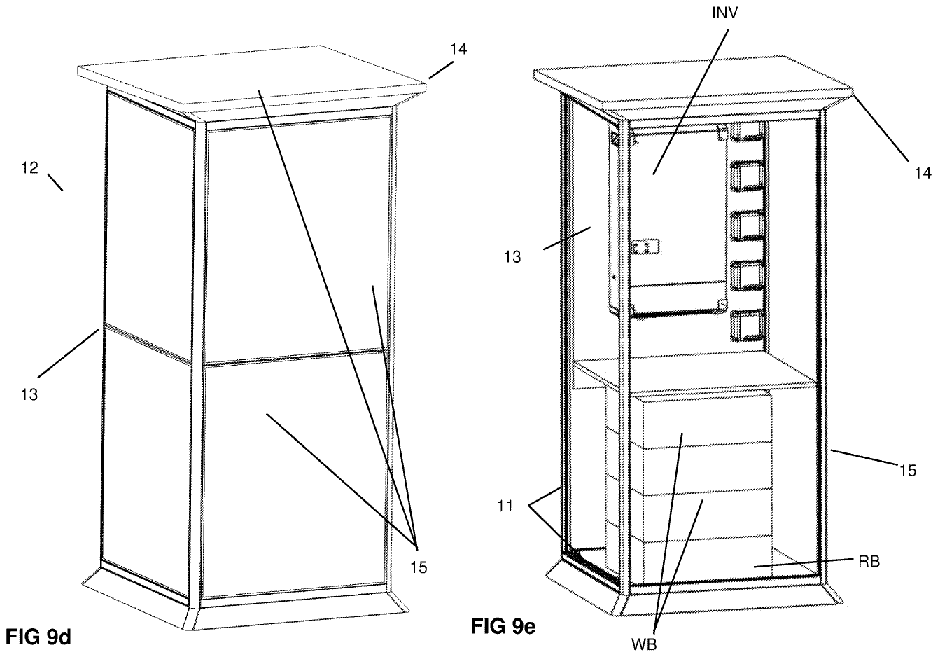

A base component, such as that illustrated in FIGS. 9a to 9e, may be made from thermoplastic polyurethane (TPU) within which holes are formed to allow the assembled structural frame or PV assemblies to be secured thereto and, together with a roof section, form the enclosure. Additionally, there are ground fixing holes to allow the base to be secured to the ground via ground screws or to a concrete slab via appropriately rated bolts. A vent in the base component allows for air to enter the cabinet from the base and is protected by a mesh to prevent ingress of insects. A water drainage hole with mesh protection may also be provided for water ingress or condensation forming within the cabinet.

The roof section 14 or optional roof PV panel 15 is joined to the internal frame via a TPU form which can be covered separately with external coloured composite aluminium panels to achieve a desired aesthetic.

In one arrangement an inverter INV may be mounted in the top left or right corner of the cabinet with 10 cm or greater clearance around it in all directions. Batteries are stacked vertically in the internal area opposite to the inverter to ensure any escaping gases from the batteries do not affect the inverter.

To extract maximum energy from the respective PV panels 15, Maximum Power Point Tracking (MPPT) controllers are provided for each PV panel covered face of the enclosure. Controllers 16 are located above the batteries on a fire-resistant backboard. Circuitry, such as a monitoring unit 19, balance the charge rate of the batteries may also be located on the backboard.

Brushless motor driven DC fans are installed within the roof TPU form component of the cabinet. Fans in combination with vents to the base and in the top of the cabinet ensure air can flow rapidly if required from the base of the cabinet to the top and atmosphere to keep internal equipment cool. The fans are triggered by a temperature sensor with a pre-set threshold.

A central LED light strip can be used to indicate visually the current status of the cells within the cabinet, their capacity level and their charge or discharge level, as well as provide a visual alert to users of any issues that may need investigating.

FIGS. 2a to 2b illustrate a first specific embodiment of structural frame element S1 in accordance with the invention. The frame element S1 has a structural body to provide rigidity to two PV panels in a planar assembly. The body includes an tubular channel which, although may be utilised for cable ducting, is adapted to receiving a reinforcing member to provide enhanced strength and rigidity to the PV panel assembly. The reinforcing member may itself be tubular, allowing for cable ducting therethrough. In a preferred construction, the reinforcing member comprised a busbar element insulated from the structural body (where formed of a conductive material such as aluminium) and from the PV panels (where the structural body is a PVC or similar extrusion) to provide a conductive pathway for power collected from the PV panels. Busbar elements for both positive (+ve) and negative (−ve) paths are ideally provided.

The mounting flange of the PV panel extrusion E is secured to an attachment surface A of the structural frame element S1 via through bolts T which engage grounding holes G within the extrusion E. The structural body of the frame element S1 includes an edge receiving profile R, which in this instance is adapted to receive a cladding component C adapted to line aesthetically or functionally insulate the interior of the enclosure. Where required a MPPT tracker circuit may be mounted on the interior of the PV panel substrate and optionally includes a cooling fan (as will be discussed more particularly with reference to FIG. 5 below).

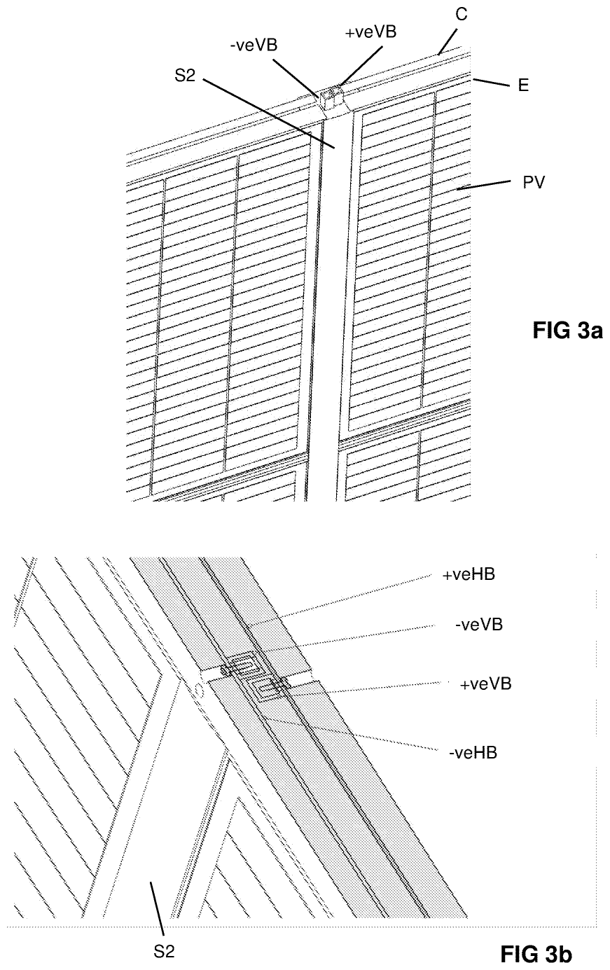

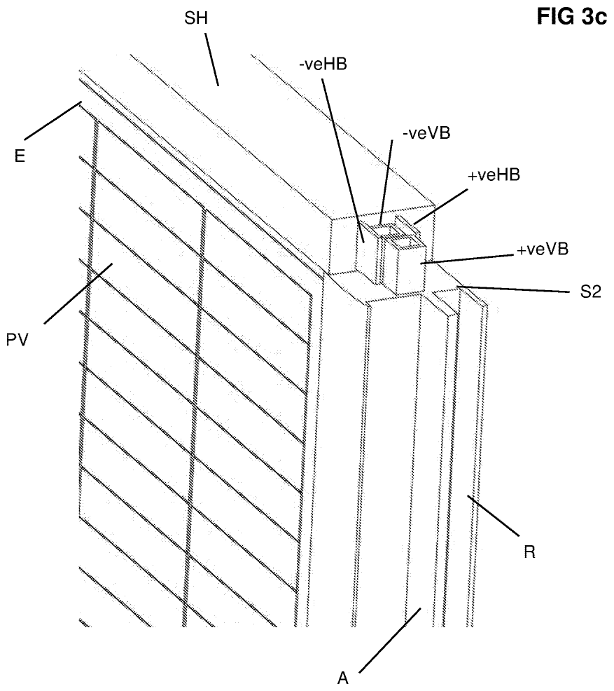

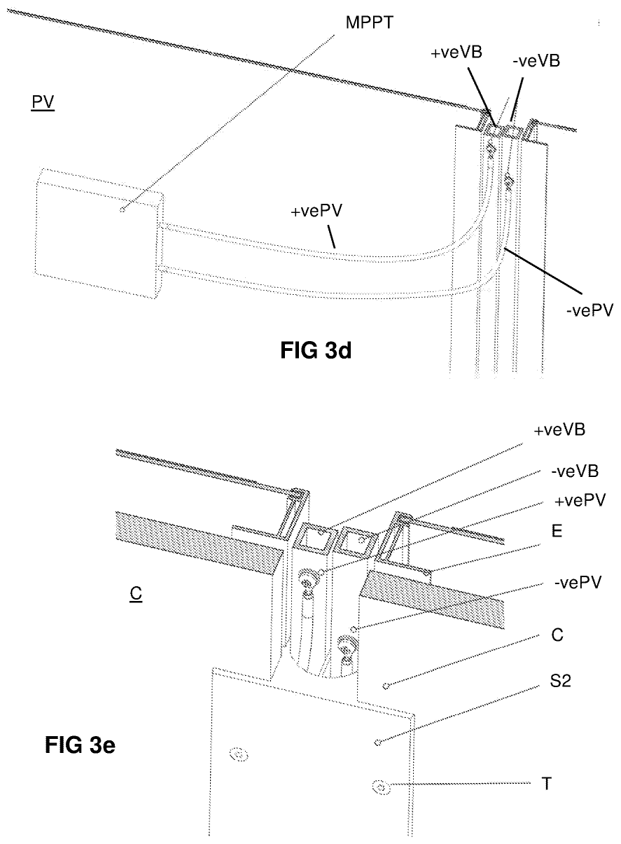

FIGS. 3a to 3e illustrate a second embodiment of structural frame element S2 in which the structural body thereof comprises a PVC or similar plastics material extrusion (to prevent thermal bridging) within which reinforcing members comprising electrical busbars are embedded.

A planar PV assembly comprising at least four PV panels is shown in FIG. 3a having a vertically disposed structural frame element S2 securing the PV panels. Within the frame element a first square-section tubular reinforcing member forms a busbar for a positive rail +veVB and a second reinforcing member forms the negative rail vertical busbar −veVB.

The two vertical conductors/busbars +veVB, −veVB are offset with respect to one another and the PV frame extrusions E by the amount of insulative plastics material required to isolate the currents conducted. The busbars are otherwise co-located to minimise generation of electromagnetic fields (attenuation of EMI). The vertical conductors, ideally being made from aluminium, provide vertical rigidity across joined PV panels, which is complimented by the inherent strength of the structural body and the internal cladding board material C.

FIG. 3b illustrates the interconnection of a positive horizontal busbar +veHB to the positive vertical busbar +veVB and the corresponding interconnection of a negative horizontal busbar −veHB to the negative vertical busbar −veVB. The availability of busbars in both the horizontal and vertical planes allows for optimised connectivity and power collection from the PV panels. It will be appreciated by the skilled addressee that series and parallel connection of PV panels is conveniently selectable according to the installation requirements of respective panels within an assembly.

FIG. 3c shows in detail the extruded form of the structural frame element S2, which includes an attachment surface A, against which the PV panel is retained via the lightweight extrusion E, and edge receiving profile R for engaging the cladding C. For larger panel assemblies, where it is necessary or desired to link vertical busbars, a horizontal frame element SH may be provided at the top and bottom of each PV panel column. The horizontal frame element SH encapsulates both positive and negative horizontal busbars therein, the busbars being disposed in such a manner as to engage with the respective vertical busbars and be secured physically and electrically thereto. Self-tapping screw or bolt and captive-nut coupling of the respective horizontal and vertical busbars provides further mechanical integrity and overcomes any contact impedance/resistance.

As shown in FIGS. 3d and 3e, ring terminal connectors crimped to positive and negative PV panel outputs +vePV, −vePV are attached via self-tapping screws to the respective vertical busbars. The output leads are routed through a channel in the frame element S2 to be positioned flush against their respective busbars. PV power outputs can be taken directly from the panels or via a regulator circuit such as a MPPT, as shown.

The form of the structural frame element S2 is not intended to be limited by the surfaces which attach to or engage with the PV panel extrusion E or the cladding C (which although preferred is not an essential part of a structural PV frame or frame assembly). The edge receiving profile R may be so sized and shaped as to receive the lightweight frame extrusion E of the PV panel.

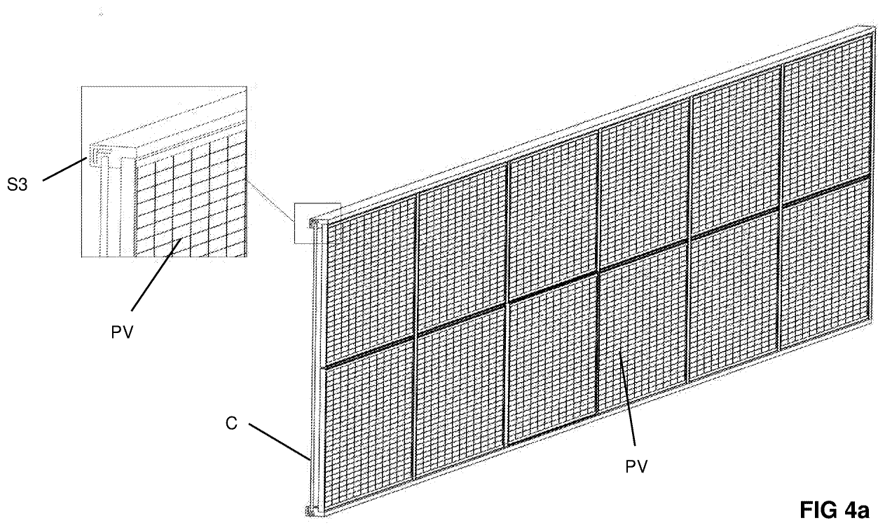

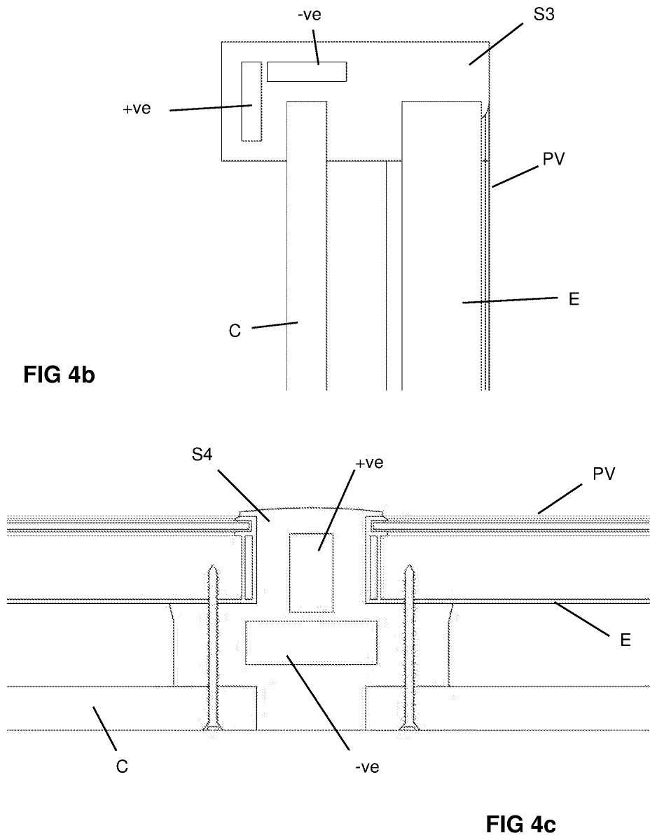

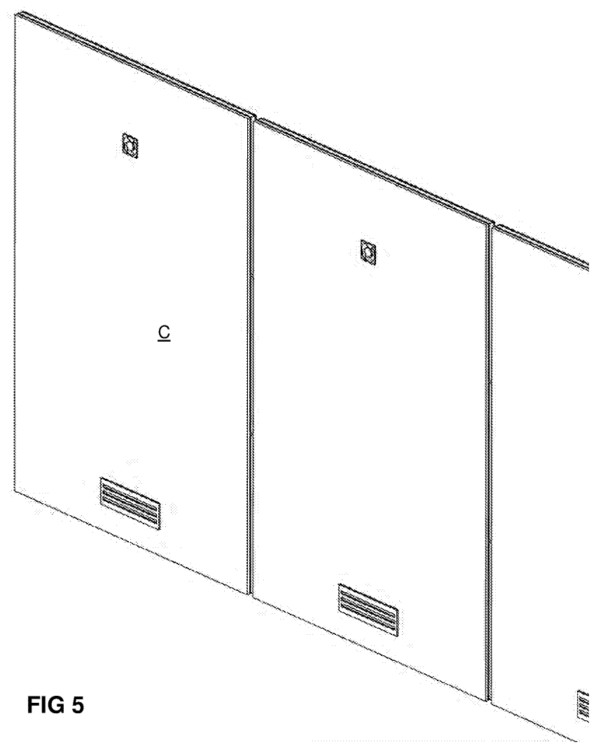

FIG. 4a illustrates a multi-panel assembly formed using structural frame elements of the invention within which reinforcing members provide busbar interconnection of the PV panels within the assembly. Structural frame elements are ideally provided around the periphery of the assembly, between each row and column of PV panels providing sufficient structural integrity to facilitate hoisting of the complete assembly.

FIGS. 4b and 4c show cross sectional views of a third embodiment and fourth embodiment of structural frame element S3, S4 each comprising an extruded structural body within which reinforcing members define isolated positive +ve and negative −ve electrical busbars.

In the third embodiment, the structural frame element S3 has busbars +ve, −ve disposed in an L-shaped configuration. In the fourth embodiment, the structural frame element S3 has busbars +ve, −ve disposed in a T-shaped configuration. Both configurations provide enhanced structural integrity in two planes, that is, in planes both parallel with and perpendicular to the planar PV assembly.

It will be understood that structural frame elements of the invention facilitate the joining of PV panels and multi-panel assemblies at any desired angle to one another and that hingedly-connected frame elements do not depart from the general overall disclosure of the invention.

FIG. 5 shows cladding boards C suitable for attachment to panel assemblies to provide ventilation and active cooling of PV panels.

PV panels and panel assemblies are preferably backed with a suitable board which may feature ventilation at the base and top to keep solar panels cool and prevent moisture buildup. A 48V powered fan may be connected to PV panel outputs +vePV, −vePV and operate within the operational range of the PV panels. The energy cost of moving air to provide cooling will generally be less than the cost of arising from decreased lost efficiency due to temperature rising beyond optimal given the loss of 0.5% efficiency in monocrystalline PV modules for each degree C increment of temperature over 25 C.

As noted hereinafter, enclosures of the invention include those forming PV power generator apparatus, ideally configured for sub-optimal generation as detailed hereinafter. Exemplifying of the prior art, a power generator assembly for supplying electrical energy for a smallholding or isolated domestic dwelling comprises an array of solar panels set out as banks connected in daisy-chain configuration via cable connectors. The panels are fixed at a tilt angle corresponding to the site latitude and face in a southerly direction for northern hemisphere sites. To augment the input from the solar panels (and provide additional power during the hours of darkness), a wind turbine may be provided. For larger power generation plants, turbines operating at medium and high voltages provide solutions with lower cost per installed kW whereas the cost of small wind turbines (SWTs) are often two to four times more costly per installed kW due to the relative immaturity of the SWT market. Many “micro wind” installations, that is, those having a rotor swept area of less than 40 m² have a rated power of between 1 kW and 7 kW. A 6 kW turbine is capable of generating up to 9000 kWh annually.

A typical domestic home uses approximately 11,000 kWh of electricity annually which equates to approximately 30 kWh daily consumption.

The direct current (DC) outputs of the PV panels and wind turbine may be routed through a fixed power output junction box to a battery bank housed within an enclosure within which voltage regulators, monitoring and control electronics is also housed in a weatherproof cabinet. Power inverters may also be found within the enclosure or optionally within the junction box where a power feed couples the power generation assembly to the demand. Mounted on a pole attached to the enclosure an optional supplementary PV panel for the control electronics may be provided.

As noted in the preamble, this arrangement has numerous disadvantages particularly for remote site locations and off-grid living demands, where robustness and serviceability are essential requirements.

The configuration of the prior art does not readily lend itself to small domestic or off-grid applications and is unsuitable for power hubs for charging electric vehicles.

As detailed hereinabove, there are notable diurnal and seasonal variances in the angle of incidence of direct solar radiation on a surface. The primary diurnal influence is the arc made by the sun (with respect to incident surface, that is, a static PV panel) during the course of the day between sunrise and sunset. Additional diurnal variances include cloud cover and shadows from adjacent vegetation or structures (such as buildings but may include other PV panels in an array). The tracking of the sun's arc using an automated tracking mechanism to retain the plane of the PV panel perpendicular to the sun overcomes much but not all of the diurnal variances but add significant overheads to the harvesting of electrical power. For static PV panels, to maximise the collection of incidental radiation they should face directly south in northerly latitudes and north in southerly latitudes, that is, positioned in an east-west plane.

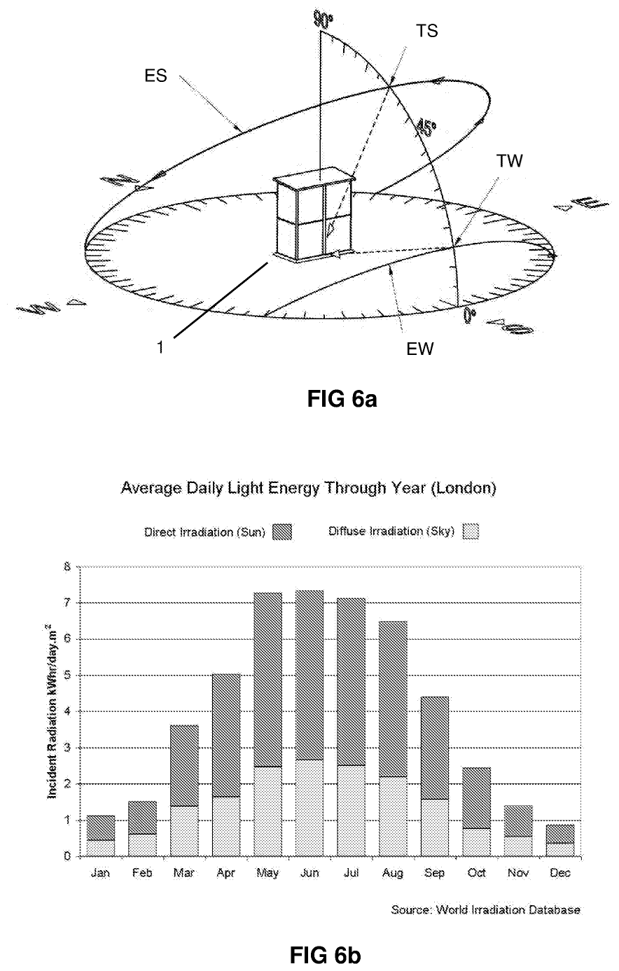

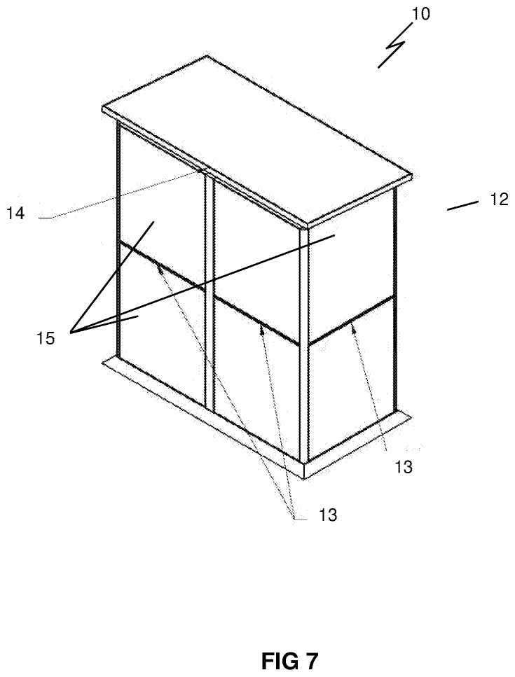

To account for seasonal variances, the angles to which the PV panels are tilted depends on the latitude of the site. In FIG. 6a, an enclosure 1 is centrally disposed within a circle on which the four cardinal directions N, S, E, W are indicated. A first line ES indicates the elevation of the daily path of the sun at the summer equinox and represents the optimal pitch or tilt TS of a PV panel to collect the maximum available solar radiation at that time of year. Similarly, a second line EW indicates the significantly lower elevation of the sun's path at the winter equinox but represents nonetheless the optimal tilt TW a PV panel to harvest solar radiation at that time of year. For a static PV panel, it is likely that the optimal tilt angle will be represented by the median of the two extremes (represented by the lines ES, EW and their corresponding tilt angles TE, TW) which will be closely aligned to the vernal and autumnal equinoxes.

In calculating the available energy that can be harvested from solar radiation it is important to distinguish between “direct irradiation” where a panel is collecting light from the sun and “diffused irradiation” where a panel is collecting light energy that has been scattered primarily by clouds or reflected/ambient light. In FIG. 6b, a bar graph showing both the direct and diffuse monthly radiation averages each month of the year at a location 51° N (London UK) measured as the average daily kilowatt hour energy incident per meter squared (kWh/day·m²). From this example, the average daily direct light available will generate approximately 0.5 kWh to 0.75 kWh of energy per meter squared of exposed PB panel during the months of November, December and January. Furthermore, the ambient or diffuse average does not exceed 1 kWh per meter squared of available PV panel for any period between October and February.

It is possible to take the combined daily average of the direct and indirect (ambient, diffuse or reflected) illumination and calculate a minimum area of PV panel required to achieve a nominal rating for an array or assembly of PV panels. Referring now to FIG. 7, a first embodiment of solar power generator apparatus 10 is shown and comprises a cabinet 12 defining an enclosure and having four planar faces 13 and a roof section 14.

In its most basic iteration, the apparatus comprises a cabinet to which vertically disposed PV panels 15 have been fixed to the front, rear and side faces, the front being a southerly facing surface in northern latitudes and has a total area of receiving PV panel to provide the rated output. For low output requirements, average daily winter output may be as little as 200 Wh which may be sufficiently to charge many electronic devices or, in one highly specific application of the invention, is used to maintain an operational current for recording, storing and transmission of collected data at a remote monitoring stations. The energy harvested may by augmented by the placement of reflectors angularly deflecting direct incident light towards the receiving panels. In a preferred construction, the roof 14 comprises a PV panel which may be pitched to optimise harvesting of solar radiation and/or prevent accumulation of snow and leaves thereon.

In a modified orientation of an enclosure having a rectangular cross-section, the front face is directed eastwardly towards the rising sun and the rear face is disposed towards the setting sun to maximise the area of incidence during the winter months and allow the southerly facing side and roof panel to collect the available light during the daily maxima.

The cabinet forms an enclosure for energy accumulation via storage battery banks and energy management or control circuitry. In the basic embodiment illustrated in FIG. 3, there are seven PV panels 15 disposed across five faces (two sides, front, rear and roof).

The PV panels are designed and rated to withstand harsh environmental conditions. In the case of a cabinet formed of extruded or profiled aluminium frame components, the resulting enclosure will have good corrosion resistance characteristics and be able to withstand heat and UV extremes. Anodized stainless steel is a preferred material for the production of an enclosure in which the panels are secured to an existing face via attachment of a border frame.

A number of environmental management features are integrated to allow the cabinet to exist within potentially quite extreme outdoor settings.

Discrete vents, protected internally by a fine internal mesh (to prevent insect ingress) are either built in to the roof frame or below the roof panel to allow hot air and any gas generated from charging the batteries to escape. Equivalent vents can be placed in the base or in the support floor to allow ingress of cool air to circulate. This feature can be supplemented with an automated and temperature-triggered waterproof cooling fan to improve the flow of air from base to top. Where there is a likelihood of operational temperatures exceeding thermal limits for the internal components, a series of fans may be triggered as predetermined thresholds are reached. An additional optional feature directs a flow of air across the PV panels to reduce surface temperature to minimise negative temperature coefficients where power generation of the PV panels may be reduced beyond that utilised by cooling fans.

An earth rod (not shown) can be placed before installation of the enclosure and connected to the frame components to allow the enclosure and equipment within to be electrically earthed, with connections from the cabinet and internal frame provided. Where ground screws are used to secure the cabinet, these may be used as part of earthing the generating apparatus.

In the case of cabinets deployed to more extreme environments, fluted corrugated plastic sheet in isolation or in combination with a commercial insulation material can be used to reduce temperature extremes within the cabinet, allowing the equipment and cells more operational range within their design parameters. An air gap between the external panel face and frame components may also be provided to prevent thermal bridging.

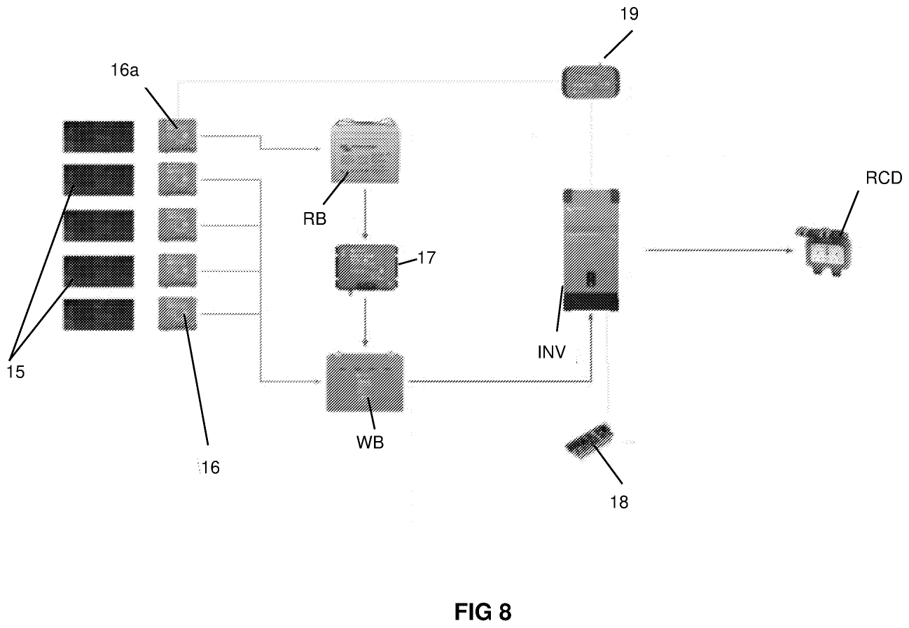

As illustrated in FIG. 8, the seven 100 W PV panels (only five are shown) are connected to charge controllers 16 for each face so as to regulate the charge current provided to the battery cells. In the exemplary construction, one of the charge controllers 16a (associated with one PV panel, hereinafter identified as the “top panel”) is connected to a reserve bank RB of deep-cycle batteries of the type described herein and capable of charging below 5 C. The remaining four charge controllers 16 channel harvested power from the remaining panels to charge a bank of batteries (designated the “working bank” WB) ideally comprising lithium ion or lithium iron phosphate (LiFePO4) cells both known to have excellent power characteristics. Power converted from DC to AC through a 2 kW inverter INV provides mains voltage via a breaker RCD or directly to a domestic dwelling consumer unit. In the embodiment shown, the output voltage is used to power a Grundfos CMBE AC boost pump P for maintaining water pressure in a feed.

The reserve bank RB powers an isolated DC to DC charger 17 which maintains an operating voltage across the individual batteries of the working bank WB. The DC to DC charger 17 is a 30 A unit designed to charge the working bank WB if individual battery voltages drop below 12.5V when the reserve bank battery voltages are over 11V.

Associated with the inverter is an actuation sensor 18 which enables a lower power standby mode. A remote monitoring unit 19 measures working and reserve battery voltages and inverter load and may include a communications module for alerting the user or a maintenance contractor. Advantageously, a pressure sensor is provided to automatically start and stop the boost pump P thereby optimising the available power.

It has been noted that with solar panels 15 feeding multiple charge controllers 16, where the PV panels each perform differently on each face with both diurnal and seasonal variations, an opportunity is presented to combine cell technologies to leverage their respective strengths and compensate for their respective weaknesses. By combining cell technologies within a generator circuit of the kind presented by the invention, it is possible to increase the longevity of both cell technologies and this is especially relevant with frequent cycling or frequent load use applied particularly through the summer months.

Advantageously, the working bank WB comprises lithium ion or lithium iron phosphate cell batteries connected together in series to create the required circuit voltage (for example, two 12V batteries to present a 24V circuit). Further batteries may be connected in parallel to provide additional capacity to the working bank where required. A charge balancer can be used to ensure that charge state differences between the cells are compensated for during the charging process.

Commercially available lithium ion and lithium iron phosphate cell batteries often feature in-built protection circuitry, cycle more deeply and more frequently than alternative technologies and have more favourable weight to kWh ratios compared to alternative technologies.

It is noted, however, that these batteries can over time degrade between charge states of 80% and 100%, is expensive per Wh compared to other battery technologies and has poor charging characteristics below 5 C.

Absorbent Glass Mat (AGM) cells making up the reserve bank RB are connected together in series to create up to a 48V circuit. The AGM batteries may also be connected in parallel to create additional capacity where required but with a limit of 3 parallel batteries per bank. A charge balancer is always used to ensure that charge state differences between the batteries are compensated for in the charging process. An over-current protection device is installed on the circuit to compensate for the lack of in-built protection features.

It is noted that AGM batteries do not tend to degrade with charge states of 100% over longer periods of time (as compared to lithium-base batteries), are inexpensive per kWh of capacity compared to other technologies, can charge at temperatures below OC and have deep discharge characteristics where they are capable of discharging up to 40% of their capacity daily for over 1,000 cycles before they start to degrade. In contrast, however, if frequently cycled at rates of more than 40% discharge for periods of over 2 hours, the battery cells can degrade more rapidly.

It is also during winter minima that the lowest temperatures are likely to be experienced so it is crucial to focus charging on the batteries having the lowest operational temperature range.

As shown in FIG. 8, the working bank WB of lithium-based batteries are charged directly from the charge controllers 16 with the exception of the charge controller 16a associated with the top panel which is connected to the reserve bank RB. The panels selected to charge the working bank WB are those which will receive the maximum solar radiation during winter minima and therefore retain as best as possible a bias towards their full charge state.

In the case where there is frequent daily cycling of the AGM reserve bank RB, there is a benefit to adding a lithium-based or alternative frequent cycling or sacrificial battery to charge from the top panel charge controller 16a, directs the majority of the cycling to this battery, reducing the depth of discharge the AGM cells experience and decreasing the time at which the lithium cells sit at a fully charged state. The isolated DC to DC converter (or charger) 17 is used to transfer energy from the lithium batteries of the working bank WB to the AGM batteries of the reserve bank RB and must be sized to charge at a rate that is as close to the rate of discharge of the AGM batteries as is achievable. The voltage drop the working bank WB experience when a load is connected via the inverter INV triggers the charging process from the reserve bank RB which continues until either the working bank batteries are fully charged or the reserve bank is depleted.

This approach reduces cycle depth of the working bank batteries, increasing their longevity whilst decreasing the time the reserve bank spends at 100% charge state, also increasing its longevity. This arrangement also directs stronger summer solar yields from the top panel to the reserve bank batteries allowing them to cycle more often and recover more quickly when solar energy is more abundant, again reducing cycling on the working bank. Advantageously, the solar panels that produce the most yield in winter to charge the bank that actually powers load, need not use energy at solar minima to retain the temperature of the working bank cells within an operational range. The energy overhead to heat the lithium cells to absorb a charge or convert energy via the DC to DC charging process at a time when energy is least abundant is therefore obviated.

The utilisation of dual cell technologies to optimise harvesting at solar minima provides additional capacity in a given system economically reducing the overall cost of the system without incurring any of the concessions a single cell technology would entail.

FIGS. 9a and 9b show a cabinet 10 similar to that of FIG. 7 having a larger capacity and an internal structural frame 11. As before, each of the walls 13 has attached to thereto a solar panel 15, ideally mounted with a panel frame (as shown in FIGS. 1a to 1c) which is fixed to structural frame elements 11 of the cabinet 12. A roof section 14 is disposed at an angle with respect to the front or rear face so to optimise solar harvesting ensuring optimal conditions in the summer months.

The cabinet is so sized and shaped as to accommodate standard batteries to form the reserve bank RB and working bank WB. Lithium-based batteries (such as lithium ion or lithium iron phosphate batteries) are used as the working cells and are provided in sufficient quantities to ensure that less than 40% depth of discharge is reached every day during the sub-optimal solar harvesting period (particularly in winter), to maximise cell longevity (each battery lasting anywhere between 25 and 40 years).

Stacking the batteries of the working bank WB and connecting them in a 4S3P configuration (that is, four batteries in series and three in parallel) delivers a maximum storage capacity of 33 kWh and a maximum power output of 15 kW (240 Volts, 60 Amps from 48V, 312 Amps) via the wall-mounted inverter INV.

The embodiment described finds utility in many guises and may be used as a hybrid grid charging cabinet having integrated solar generation.

FIG. 9c illustrates a minor but important modification to the arrangement of this embodiment of solar generator enclosure in which the working bank is arranged as a linear stack. In a preferred construction, a standard 19-inch rack structure may be used and selected components, such as lithium battery packs, inverters and charge controller circuits may be packaged for simple demountable connection within a rack.

FIGS. 9d and 9e exemplify a further construction of the first embodiment of solar power generator enclosure in which the internal frame 11 provides support for standard industrial rack-mounted components, such as rack-mountable lithium packs as noted above. As production is scaled, the availability of reliable, inexpensive and potentially “plug and play” component modules become standardised, power connections including ground connections to the frame elements, will facilitate ready expansion of the capacity of the enclosures of the invention. As noted below, the invention may be provided in a “kit of parts” form, allowing a purchaser to select minimum operating components and to increase capacity, add reserve bank batteries or incorporate external sources of energy, as desired.

In the illustrated embodiments, the charge controllers 16 and the inverter INV are mounted to a back panel (with 10 cm clearance around the inverter), however, these components may be provided as rack-mounted alternatives.

The enclosure may include sheet aluminium or steel panels to which the PV panels are fixed. This facilitates the direct attachment of PV panels to the enclosure. Alternatively, the PV panels are mounted within frames which are then secured to the sheet panels of the enclosure. In the most preferred constructions, PV panels mounted within rigid frames form the front, rear and side faces (and ideally the roof section) of the enclosure.

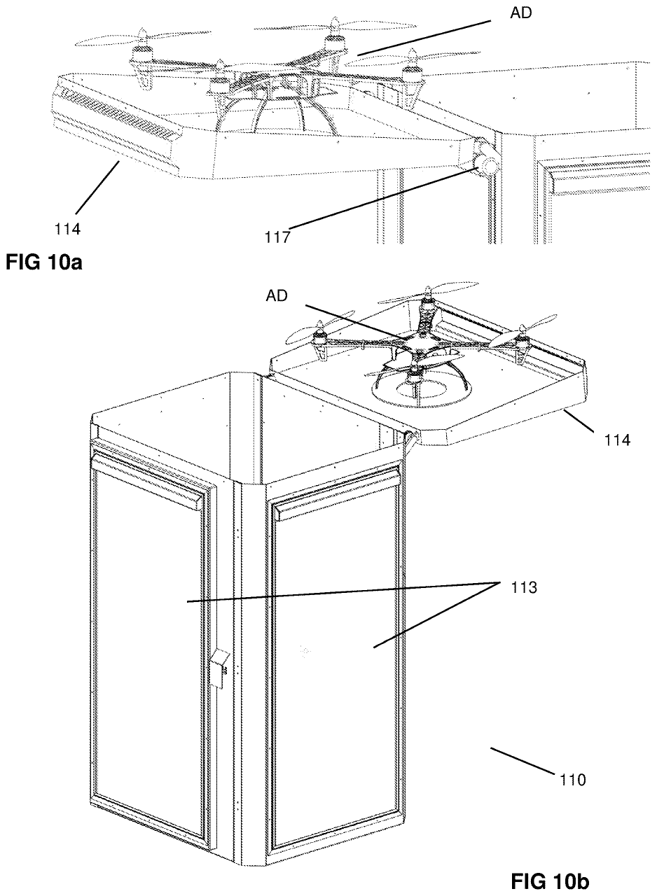

FIGS. 10a and 10b show a generator apparatus 100 which includes a landing and charging platform for an autonomous vehicle such as an aerial drone AD. The roof section 114 of the cabinet is adapted to pivot open around a motor-driven shaft 117. The drone is locked magnetically to the inner side of the roof section from which it may be deployed when release power is applied to disable the magnetic lock. Charging of the drone battery is wireless via inductive coupling. During deployment of the drone, the roof section is closed to avoid shading of the PV panels 113 and allow for further charging via the roof section PV panel where provided.

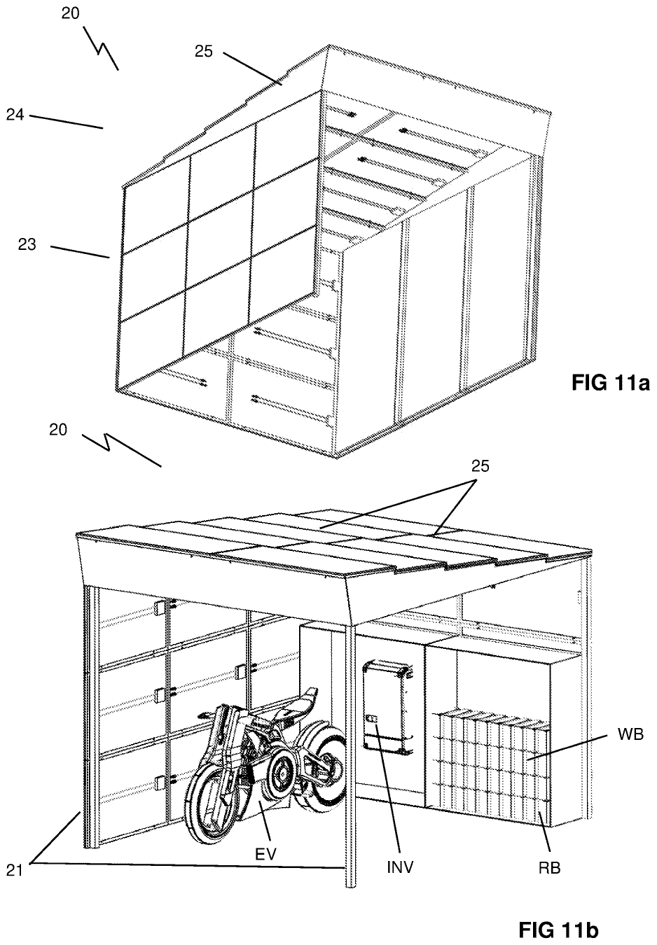

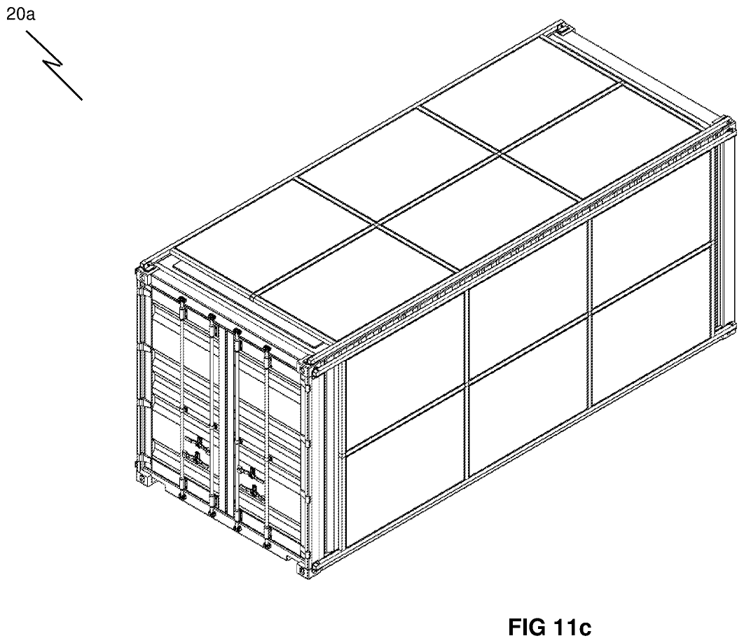

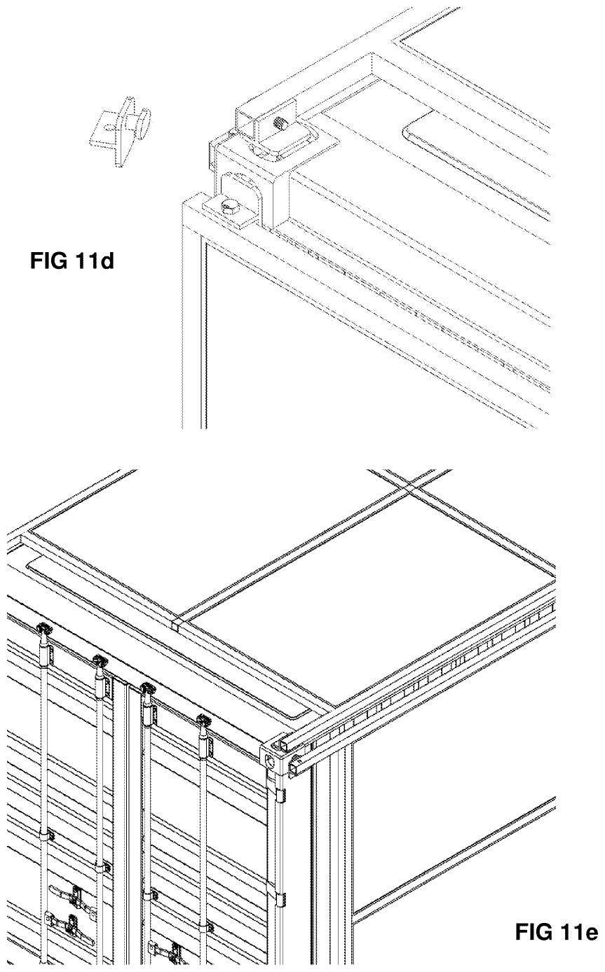

Referring now to FIGS. 11a and 11b which show a garden shed or small garage structure 20 having structural frame elements 21, front, rear and side walls 23 and a sloping roof section 24. Each wall is covered with PV panels 25 which are either fixed to existing walls or are mounted within frames which are secured together and along their peripheral edges to the frame elements 21 of the enclosure. One wall may include a door (not shown) or be formed as a complete hinged section.

The roof section 24 is shown as a pitched shingle style construction where the PV panels 25 substitute the shingle tiles, however, a single sheet roof may also be provided to which the PV panels are fixed. As before, the pitched angle of the roof is determined by individual or site requirements and may be oriented towards the summer sun at its diurnal peak. In the exposed view of FIG. 11b, a front wall (or door) and a side wall 13 have been detached to expose the interior layout in which a bank of batteries WB, RB, connected in a configuration similar to that discussed with respect to FIG. 8 or FIG. 9b are disposed along a rear wall together with the associated inverter INV and control circuitry. Electrical outlets may be provided for illumination both inside and outside the enclosure and for charging points for electric vehicles EV from scooters and electric bikes to electric motorbikes (as illustrated) and cars. A wall mounted reel (not shown) for an EV cable may provide convenient connectivity adjacent the garage.

The solar yield provided by PV panels on the roof section 24 and front, side and rear faces 23 affords a useful quantity of energy to power an inverter INV that can charge an EV at rates over 2 kW using stored energy in the working bank WB.

Panels are optionally joined together via 3D printed joints that secure within the corner of each aluminium frame interior of each solar panel face and have a central hub that bolts them together to form a strong network of connections across the face. These can be optionally hinged to allow the panels on each face to open in a concertina fashion to allow full access to the inside equipment.

Insulation can be installed within the panel apertures to provide an improved stability of temperature within the structure.

The aperture between the angled roof panels and the side and front panels can be lit with an LED light strip to indicate charge status and solar yield via changing colour and patterns.

The second construction of generator enclosure may be scaled from garden shed proportions to a barn or industrial unit, such as a distribution centre. In FIGS. 11c to 11e, a shipping container is provided with a structural frame PV panel assembly with support beams adapted for hanging on locking brackets constructed to engage twist lock receivers on the body of the shipping container.

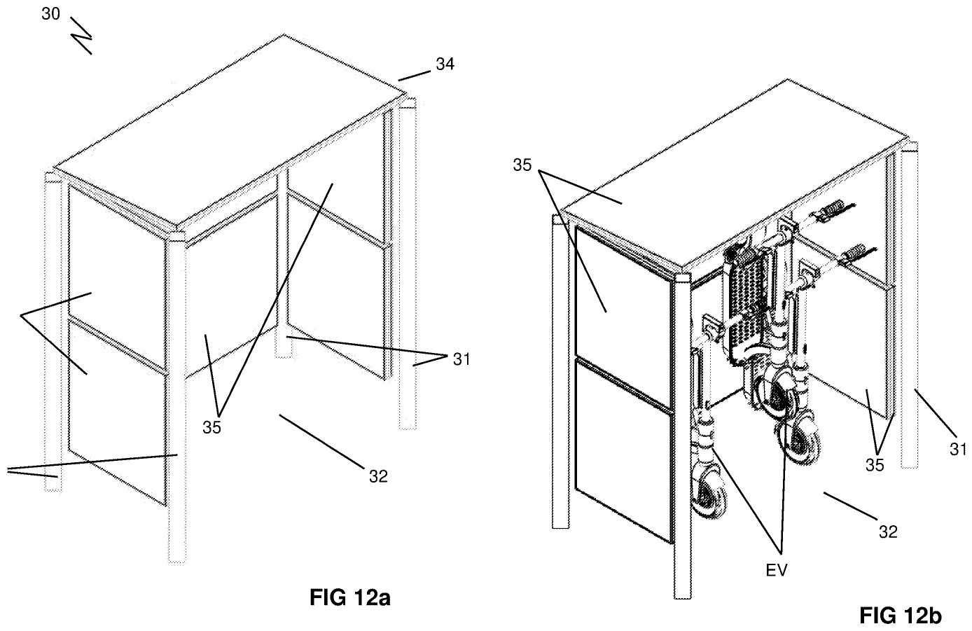

A further family of enclosure constructions includes a solar generating apparatus 30, as illustrated in FIGS. 12a and 12b, formed to present an open-faced cabinet 32 comprising structural frame elements 31 and a series of PV panels 35 disposed therebetween. As the cabinet is open, diffuse light may be utilised by using double-sided PV panels. Conveniently, panel frames are provided to mount the PV panels back-to-back and may incorporate charge controllers/regulation to manage the mismatched voltages generated by the paired panels and to facilitate fixing of the mounted panels 35 to the structural frame elements 31.

In the construction shown, there are two panels 35 (each double-sided) disposed one above the other on each side wall, a pair of upper and lower panels (which need not be double-sided) on the rear wall adapted to accommodate mounting hooks and charging points for foldable electric scooters EV, as shown in FIG. 12b. Batteries forming the working bank WB and reserve bank RB may be housed within the enclosure at ground level. The use to which the cabinet is applied, that is, as a charging station, obviates the requirement for an inverter. An additional communication module allowing for payment verification may be mounted on the interior rear wall or more conveniently adjacent the open mouth of the cabinet.

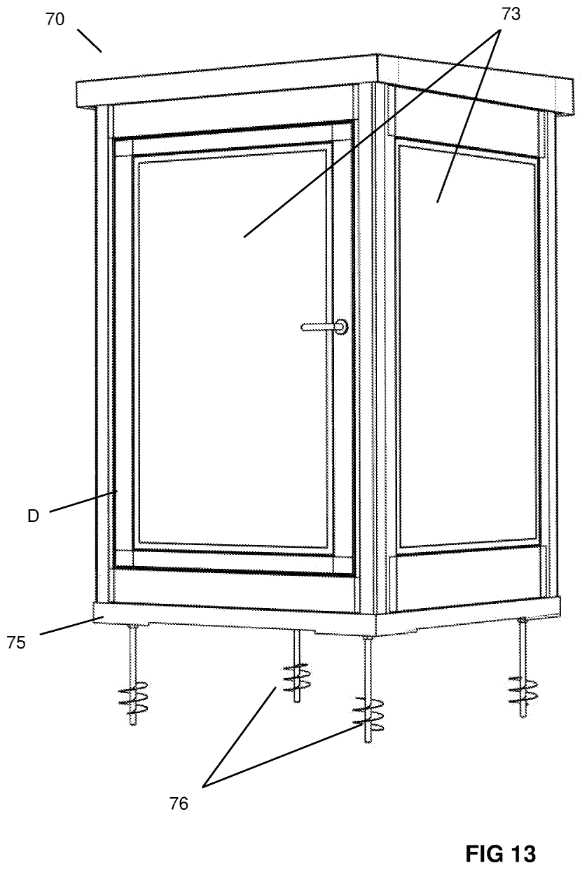

An enclosure or generator apparatus of the invention may be constructed as a remote monitoring station for providing power to air or water sampling apparatus and associated transmission thereof via a communications module. In FIG. 13, the remote monitoring station 70 is constructed to house a test facility and includes a door D for access to authorised personnel. PV panels 73 are mounted on all major faces including the door and ideally also on the roof section. The monitoring station is mounted into a base plate 75 from which ground screws 76 fixed at each corner of the base plate 75 secure the station 70 in place.

It will be appreciated from the foregoing that a number of ground fixing methodologies may be utilised and that larger power generation installations may require a load-bearing bed or concrete pad.

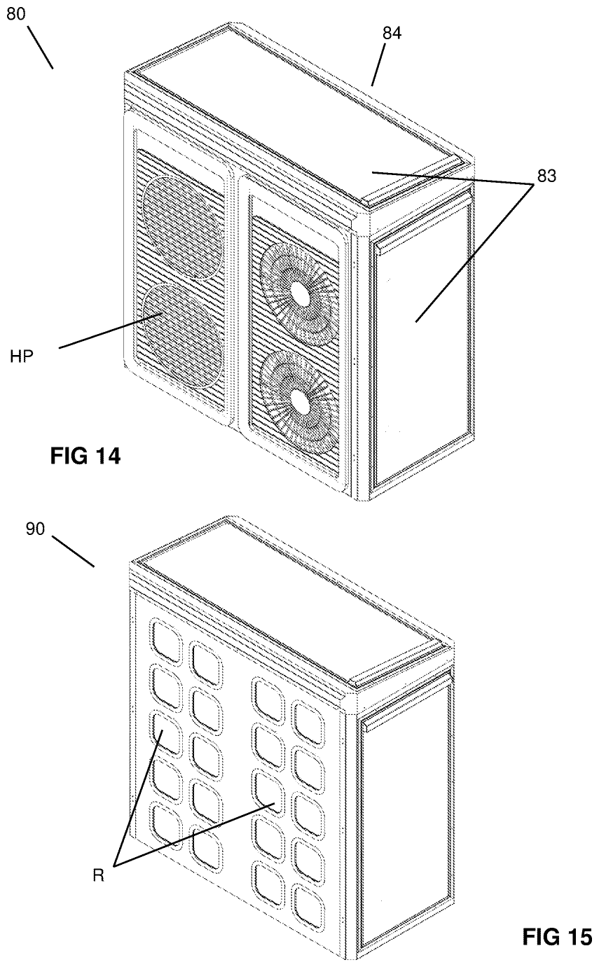

In many domestic homes gas-fired central heating is being replaced by ground source or air source heat pumps and legislation in a number of jurisdictions precludes the supply of town gas to new-build properties. It is a generally underappreciated fact that heat pumps consume significant power and may have a significant financial impact on users. A modified power generator 80 of the invention may be integrated with a heat pump HP as shown in FIG. 14 to attenuate the costs of use. PV panels 83 are positioned on all available major faces including the roof section 84. To avail of the optimum configuration for harvesting solar radiation, the heat pump vents are disposed on the face directed away from the arc subtended by the sun.

A variant of the power generating apparatus comprising a charging station 90 is shown in FIG. 15, in which the face presented away from the arc subtended by the sun is replaced by a face within which a plurality of battery receptacles R is provided. Each receptable is adapted to receive a removeable EV battery, for example, from an electric motorcycle, bicycle or foot scooter. Where the charging station 90 is commissioned by a single manufacturer, the receptacles may include a charge coupling which connects directly to the EV battery. This arrangement facilitates a battery-swap scheme, where a fully charged battery may be retrieved from a receptacle when a receptacle door is released after verification that a valid and rechargeable battery has been deposited and payment verification has been made. In other circumstances, terminal connections may be provided for a range of batteries, however, charging will only commence after the receptable door is closed and, where provided, payment verification has been made. To facilitate card payments, a communications module for verification of payment may be mounted within the cabinet. In a preferred arrangement, battery charging is accelerated for newly deposited batteries and batteries which have been fully charged become part of the working bank WB or reserve bank RB according to predetermined charging criteria.

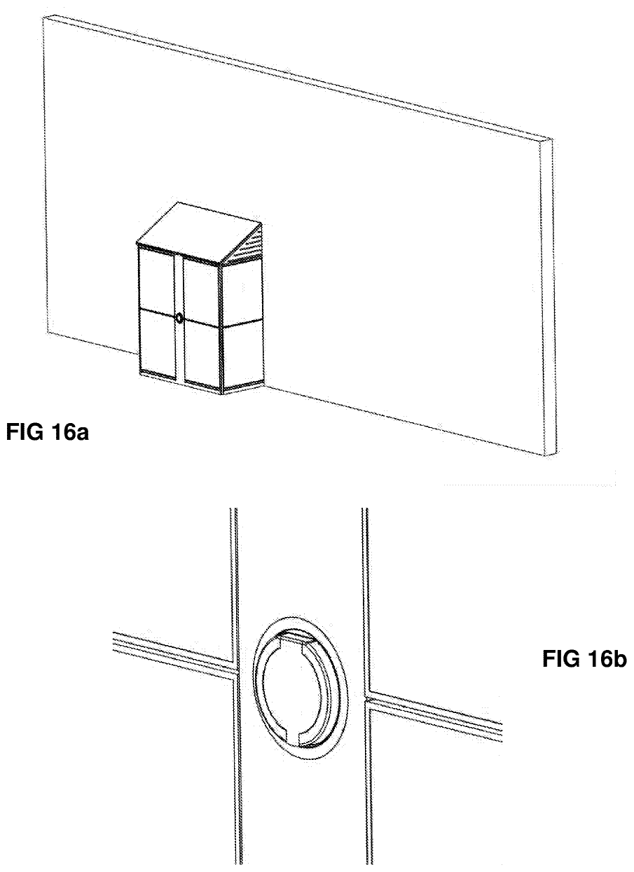

FIG. 16a is a perspective elevation of an enclosure similar to that of the second embodiment in which one major surface of the enclosure abuts or is integral with a wall (including a building wall) ideally facing south in northern latitudes having a pitched roof section angled for optimum insolation at the latitude sited;

FIG. 16b is a outlet socket for attaching a power cable where the enclosure is optimised for external power generation, for coupling to an EV for example;

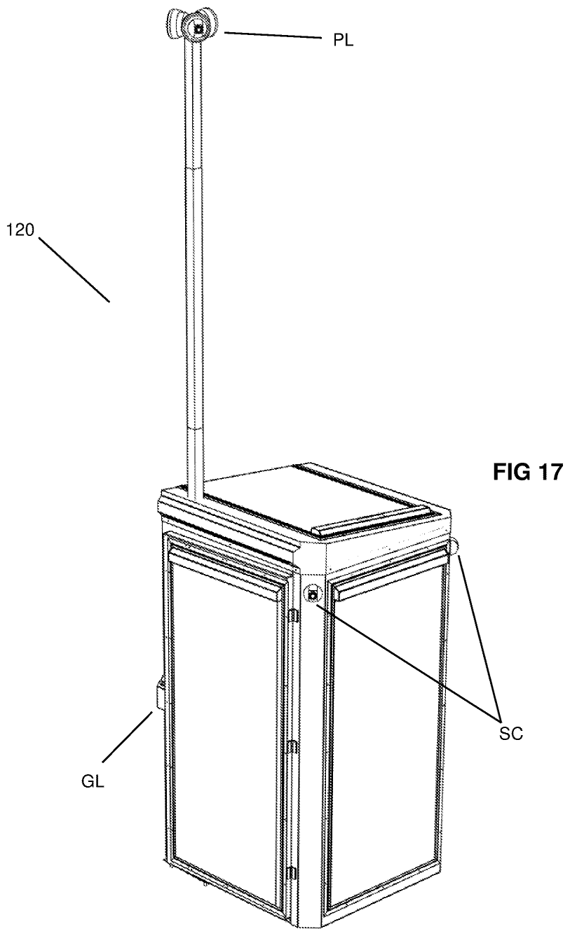

FIG. 17 shows a generator apparatus 120 having enhanced security features which include cameras SC mounted on minor faces of the cabinet and a reinforced guarded lock GL. In one construction as illustrated, a camera platform PL is mounted on a pole which is ideally telescopically extendable from the cabinet interior optionally deployable from within the cabinet by pivoting the roof section in a manner similar to that shown in FIGS. 10a and 10b.

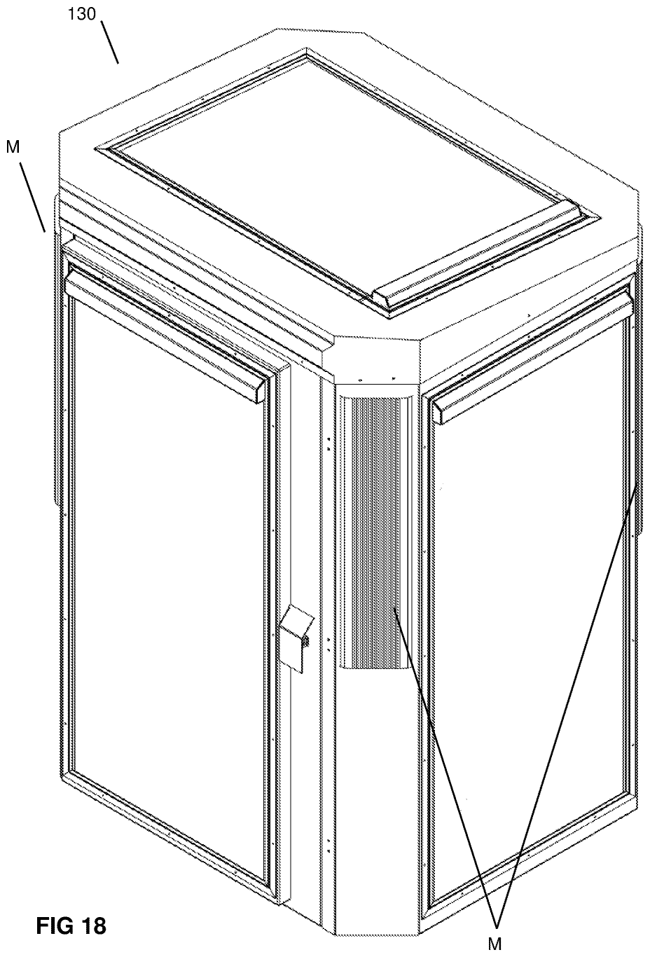

FIG. 18 shows a generator apparatus 130 which can include any of the enclosure configurations described or as shown in the accompanying drawings has mounted on at least one minor face of the cabinet housing, a communications module. In the construction shown, cellular base station modules M are disposed on each of the minor corner faces. Additional circuitry associate with the or each module is housed within the cabinet.

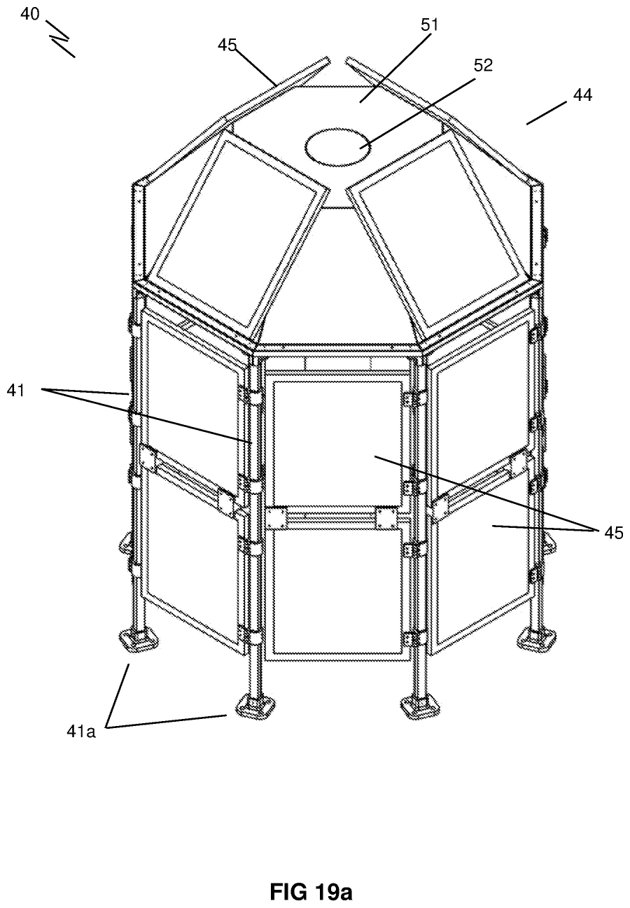

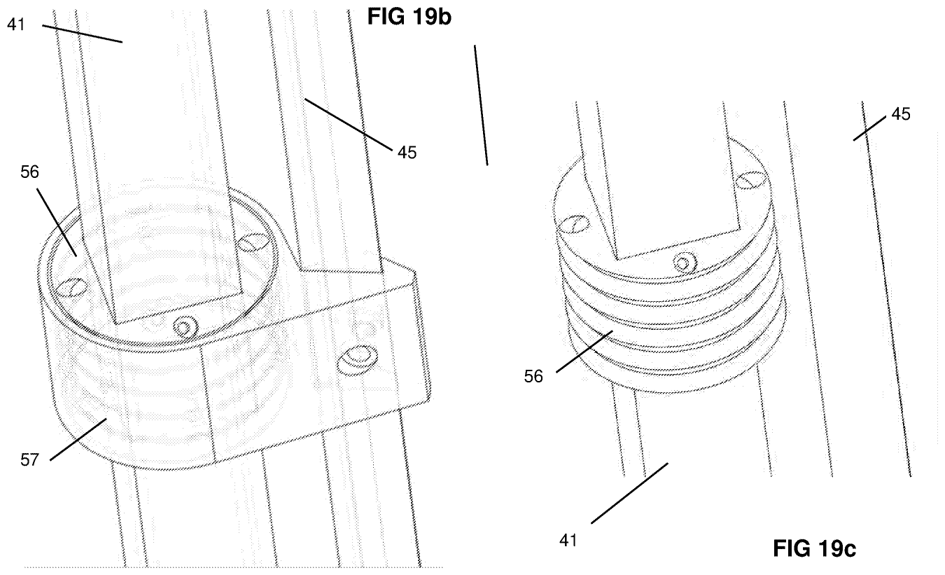

A fourth embodiment of solar power generator apparatus 40 is shown in FIG. 19a and comprises a self-supporting, grounding-engaging structural framework of a substantially octagonal cross-section, having eight upright frame elements 41, to which are attached PV panels 45 in a vertical orientation. The upright frame elements support a roof section 44 on which there are disposed four PV panels 45 angled to optimise solar energy harvesting. The roof section also includes a support plate 51 defining a central aperture 52.

Sealingly enclosed within the framework, the reserve and working battery cells, together within the control circuitry are arranged in a configuration determined by the proposed utilisation of the generator. Where the generator is designed as a stand-alone device, feet 41a at the bottom of each upright frame element may be anchored to the ground or to a concrete bed. Where the generator is designed to be lifted or hoisted into a remote or inaccessible area, the support plate 51 includes an attachment point, such as a lifting eye rated for the weight of the generator with batteries. In an alternative construction, the support plate aperture 52 can accommodate the support pole of a wind turbine to augment the power harvesting reliability of the generator. The generators are constructed as stand-alone devices but may be linked to further devices to form an array.

FIGS. 19b and 19c are perspective elevations of hinge details of at least one framed panel 45 adapted to facilitate access to the interior of the enclosure illustrated in FIG. 19a.

A vertical pair of solar panels 45 are attached to a frame upright 41 by a 3D printed panel joint by a profiled pivot component 56 which is rotatably received in a clamp member 57 operably supporting the weight of the framed PV panel 45 and having a biasing mechanism therein to return the panel to its normally closed position where it may be latched shut. A magnetic latch mechanism, electrically operated by payment card verification, may be used to provide enhanced security. The pivot component 56 and clamp member 57 may be 3D printed or otherwise formed from a thermoplastic material such as TPU and have internal features to prevent rotation beyond the desired range of movement.

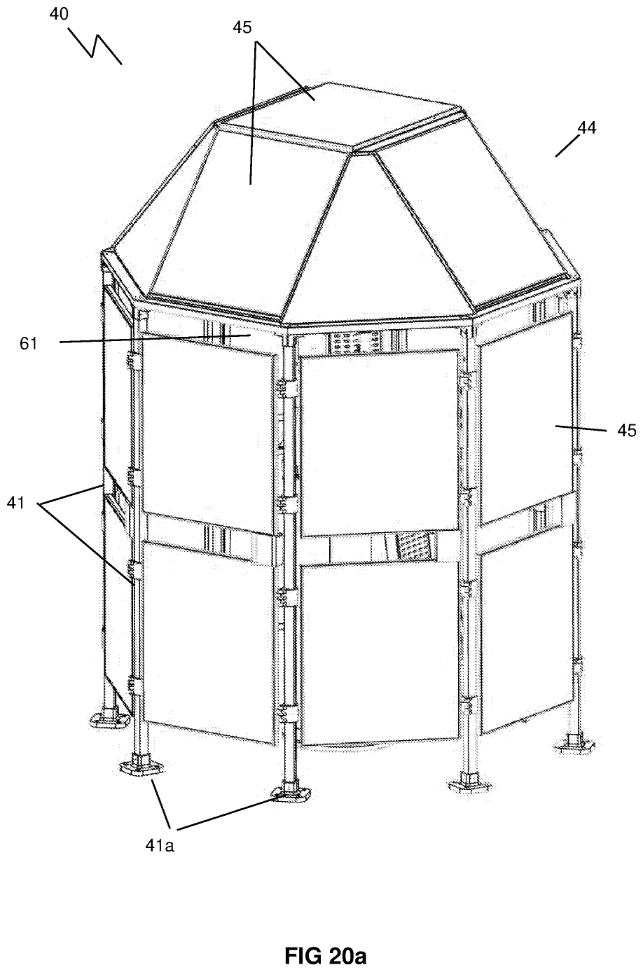

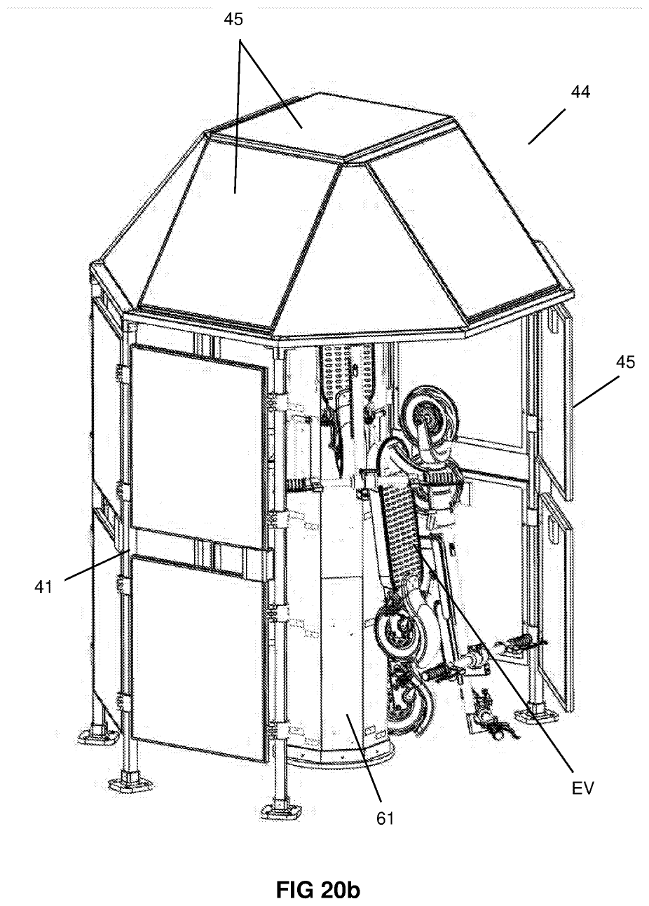

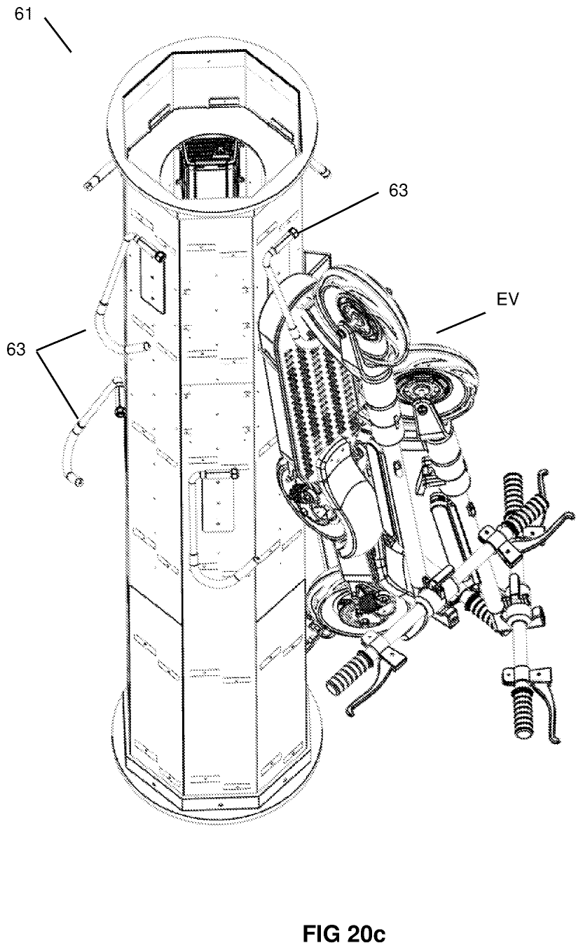

Finally, with reference to FIGS. 20a and 20b, a specific combination of the fourth embodiment 40 of the invention comprises a charging station 42, ideally for electric bikes and scooters EV. Similarly to the apparatus shown in FIG. 19a, the charging station 42 comprises a self-supporting, ground-engaging framework of octagonal cross-section having upright frame elements 41, each being provided with an anchor plate 41a for securing the station to the ground. As before, PV panels 45 are secured between the upright elements, however, pairs of panels are latched on one side to provide an access door, utilising the mechanism described with reference to FIGS. 19 b and 19 c, to a centrally disposed charging column 61 to which or on which foldable electric scooters EV are attached for storage whilst charging. The upright frame elements 41 also provides support for a roof section 44 on which further PV panels 45 are arranged.

The central charging column 61, as detailed in FIG. 20 c, houses the battery banks WB, RB and charging regulators required for charging the electric scooters. A communications module to facilitate card payment verification may also be integrated into the charging column. In a preferred arrangement, mounting hooks 63 are arranged at discrete heights around the charging column 61 to allow folded scooters EV to be stacked thereon providing maximum space internally for the geometries of a folded e scooter or other powered mobility device.

Ideally, a pocket is provided to house a user's own AC charger to guarantee compatibility with the widest range of e-scooters or other mobility devices.

It will be appreciated by the skilled reader that the above embodiment 40 is not limited to rectangular or octagonal cross-sections and that in certain circumstances other profiles including hexagonal and triangular may be preferred.

The invention yet further provides a kit of parts for forming framed PV panels and system, the kit of parts comprising:
a selected number of PV panels mounted within frames in a selected configuration;
a charge controller rated to the maximum voltage and current generated for each presented face of the framed panels to match the power conversion algorithms of the controller; and
a manual isolating switch, automatic circuit breakers, fusing and bus bars to provide selected and fault-triggered isolation and operationally aggregate charge from the charge controllers to battery cell terminals.

Advantageously, the PV panels include toughening layers on all faces to maximise indirect yield of solar radiation.

The frames may comprise stainless steel for rigidity and strength or profiled aluminium for a combined characteristic of strength with lightweight.

Ideally, pairs of PV panels are mounted in a single frame and electrically connected in series to maximise the generated voltage.

The kit of parts further provides, for high demand applications and where AC power is required:
a discrete DC charge controller; and
an inverter with manual isolation switch.

Optionally, there is additionally provided a first working battery bank and a reserve battery bank.

In the preferred arrangement, the reserve battery bank comprises AGM batteries provided in a configuration associated with the required system voltage, for example, 4S3P for a 12v system, and the working battery bank comprises lithium-based batteries, such as those based on lithium ion or lithium iron phosphate cell technology, provided, if appropriate, in a configuration associated with the system voltage, for example, 4S1P.

The isolated DC charge controller is rated to charge at twice the maximum load when transferring energy from the AGM battery bank to the lithium bank.

The inverter is rated up to 15 kW to convert energy from the working bank to AC for distribution via Ingress Protection (IP) rated outlets. Support for automatic load protection and standby power mode to reduce background energy usage.

For utilisations involving consistent, year-around usage with either AC or DC powered devices:
the deep discharge working bank (lithium batteries) is sized to 250% of the maximum daily power (Wh) load to ensure a bias towards discharging the working cells to less than 40% of capacity thereby maximising their service life.

For utilisations servicing multiple low-load devices (rather than fewer high-load devices) a unitary device combining a solar charge controller and inverter is provided per device output (in effect, one per PV panel face), with standby mode functionality to minimise background load.

It will of course be understood that the invention is not limited to the specific details described herein, which are given by way of example only, and that various modifications and alterations are possible within the scope of the appended claims.

1. A frame element for forming a photovoltaic (PV) panel having structural integrity, the or each frame element comprising:
a body providing rigidity to the frame element:
the body having an attachment surface operably securing a frame element to another frame element or surface to which the formed PV panel is to be secured and an edge receiving profile;
the body having constrained therein a reinforcing member along substantially the length of the frame element, the reinforcing member being conductive and insulated from the PV panel by the body,
wherein the or each conducting reinforcing member comprises a busbar for a selected polarity to which a PV panel is operably connected.

2. A frame element as claimed in claim 1, in which the reinforcing member is tubular.

3. A frame element as claimed in claim 1, in which at least two isolated reinforcing members are provided within the body.

4. (canceled)

5. A frame element as claimed in claim 1, in which substantially rectangular reinforcing members are positioned proximate one another to attenuate electromagnetic interference (EMI) associated with the conducting of power from the PV panels along the busbars.

6. A frame element as claimed in claim 5, in which reinforcing members are positioned substantially perpendicularly to one another to provide structural reinforcement in two major axes.

7. A frame element as claimed in claim 5, in which positive and negative polarity busbars are provided in one or both of the horizontal and vertical planes.

8. A photovoltaic (PV) panel of enhanced structural integrity having at least one frame element of the type claimed in claim 1, the attachment surface of at least one frame element including attachment means selected from any one of:
a fixing member for securing one frame element to another;
a ground-engaging foot or fixing;
a fence post having frame element receiving channels defined therein; or
a locking member for securing a frame element to a shipping container lock receiver.

9. A PV panel as claimed in claim 8, in which the attachment means is operationally adapted to secure a panel to a building or enclosure surface.

10. A PV panel as claimed in claim 8, in which the or each frame element is fixed to a framework.

11. A PV panel comprising a plurality of PV panels of the type claimed in claim 8 positioned within frame receiving channels of a series of fence posts.

12. A PV panel as claimed in claim 8. in which PV panels are adapted to form a self-supporting enclosure.

13. A modular photovoltaic (PV) system comprising:
a PV panel formed using structural frame elements of the type claimed in claim 1;
attachment means for engaging the attachment surface of the frame element;
in which each PV panel is secured to a structural frame element having at least one reinforcing member defined therein, and
in which the attachment means is selected from any one of:
a fixing member for securing one structural frame element to another;
a ground-engaging foot or fixing;
a fence post having frame receiving channels defined therein; or
a locking member for securing a frame element to a shipping container lock receiver.

14. An enclosure for a photovoltaic (PV) device on which PV panels operably form at least two of the major faces thereof, the enclosure comprising:
structural frame elements of the type claimed in claim 1 and an attachment means for securing the enclosure to the ground or to a building surface;
a plurality of PV panels secured to the structural frame elements to define vertical faces of the enclosure;
sealingly disposed within the enclosure, control circuitry for regulating the electrical energy generated via the PV panels and energy accumulators connected to the control circuitry; and
a regulated electrical outlet means,
in which at least two of the PV panels are disposed on said major faces, of which at least one is directed towards the path followed by the sun (due south in northern latitudes) and the other of said at least two PV panels is selected from PV panels disposed substantially perpendicular to the first PV panel and PV panels mounted to a roof section.

15. An enclosure as claimed in claim 14, in which the enclosure is selected from any one of: a prefabricated purpose-built enclosure, a garden shed, a domestic dwelling, a shipping container, a pre-fabricated metal building (including barns, livestock shelters and silos), industrial buildings, warehouses and distribution centres.

16. An enclosure as claimed in claim 14, in which the enclosure is adapted as a remote monitoring or signal repeating station in which the energy accumulators ensure power is maintained for data collection, storage and transmission.

17. An enclosure as claimed in claim 15, in which one of the major faces includes an access door.

18. An enclosure as claimed in claim 14, in which the structural frame elements releasably retain the PV panels and include hinge elements at their peripheries to facilitate access to the interior of the enclosure.

19. An enclosure as claimed in claim 14, in which each face having a PV panel thereon has associated therewith a dedicated and appropriately rated charge controller to manage the solar power harvested from each panel within a face to maximise the efficiency of the charging output generated.

20. An enclosure as claimed in claim 14, in which the enclosure is adapted to receive, store and charge batteries from electric vehicles (EVs).

21. An enclosure as claimed in claim 14, in which the enclosure is adapted to receive, store and charge EVs from electric kick-scooters, electric motorcycles and electric cars (obviating the necessity of external or mains powered electrical connections).

22. An enclosure as claimed in claim 14, in which the enclosure has an octagonal cross-section whereby framed PV panels are hinged to form access door to a centrally disposed charging structure on which electric kick scooters are suspended for storage and charging.

23. An enclosure as claimed in claim 14, in which the enclosure is open on one of its faces and in which at least one face of PV panels comprises an arrangement of formed PV panels in back-to-back configuration so as to receive indirect or reflected solar radiation within the open mouth of the enclosure and whereby EVs have access to charging facilities at the open mouth thereof.

24. An enclosure as claimed in claim 14, in which the enclosure includes a communications module.

25. An enclosure as claimed in claim 14, in which the enclosure includes payment verification means.

26. A photovoltaic (PV) power generator apparatus on which PV panels operably form at least two of the major faces thereof, the generator comprising:
a cabinet housing defining said major faces and a roof section thereof, the cabinet having structural frame elements of the type claimed in claim 1 and an attachment means selected from a ground-engaging element and a building surface securing support;
a plurality of PV panels secured to the structural frame elements to define selected major vertical faces of the cabinet housing;
sealingly disposed within the housing, control circuitry for regulating the electrical energy generated via the PV panels and energy accumulators connected to the control circuitry; and
a regulated electrical outlet means,
in which at least two of the PV panels are disposed on said major faces, of which at least one is directed towards the path followed by the sun (due south in northern latitudes) and the other of said at least two PV panels is selected from PV panels disposed substantially perpendicular to the first PV panel and PV panels mounted on a roof section.

27. A PV power generator apparatus as claimed in claim 26, in which the energy accumulators comprise a bank of batteries having deep-cycle characteristics and a bank of batteries having high power delivery characteristics and wherein combining cell technologies with charge controllers and voltage monitoring circuitry optimises both charging and delivery of power in sub-optimal conditions.

28. A PV power generator as claimed in claim 26, having at least one major vertically disposed face, in which PV panels operably form at least the major faces thereof to optimise the harvesting of solar radiation in sub-optimal conditions with respect to diurnal and seasonal variances of direct and indirect incidence of solar radiation.

29. A PV power generator as claimed in claim 26, in which each face having a PV panel thereon has associated therewith a dedicated and appropriately rated charge controller to manage the solar power harvested from each panel within a face to maximise the efficiency of the charging output generated.

30. A PV power generator as claimed in claim 26, in which a storage cell array delivers a direct current (DC) power output to devices or a local power connector or via an inverter to provide an alternating current (AC) power output.

31. A PV power generator as claimed in claim 26, in which the first battery bank comprising a working bank of frequent and deep cycling cells, having superior weight to kWh ratios and the second battery bank comprising a reserve bank providing additional charging capacity and lower charging temperature capabilities that the working bank cells, each bank having charge balancers to compensate for charge state differences during a charging and discharging cycle.

32. A PV power generator as claimed in claim 26, in which the first battery bank comprising lithium ion or lithium iron phosphate batteries and the second battery bank comprising Absorbent Glass Mat (AGM) cells, each provided in a configuration associated with the required system voltage.

33. A PV power generator as claimed in claim 26, in which the total surface area of PV panel is optimised to generate a daily average power generation of at least 200 Wh.

34. A PV power generator as claimed in claim 26, in which a storage cell array delivers a direct current (DC) power output to devices or a local power connector or via an inverter to provide an alternating current (AC) power output.
